(19) United States
(12) Patent Application Publication
(10) Pub. No.: US 2024/0354762 A1
(43) Pub. Date: Oct. 24, 2024

(54) ENHANCED DATA MESSAGING SYSTEMS AND METHODS FOR AUTHENTICATING AN IDENTITY OF ONLINE USERS

(71) Applicant: MASTERCARD INTERNATIONAL INCORPORATED, Purchase, NY (US)

(72) Inventors: Rajesh Janu, Lexington, MA (US); Hemani Shringi, North Bend, WA (US); Valerie Matusiak, Weehawken, NJ (US)

(21) Appl. No.: 18/301,021

(22) Filed: Apr. 14, 2023

(51) Int. Cl. G06Q 20/40

(52) U.S. Cl. CPC G06Q 20/4014; G06Q 20/4016

(57) ABSTRACT

An authentication platform for authenticating an online user is provided. The authentication platform includes a memory device and at least one processor coupled to the memory device. The at least one processor is programmed to generate an authentication model using historical data. The at least one processor is further configured to receive, from a merchant computing device, an authentication request message for a current transaction, the authentication request message including consumer identity data for the current transaction and extract the consumer identity data from the authentication request message. The at least one processor is further configured to generate, based on the extracted consumer identity data, identity insight result data using the authentication model, inject the identity insight result data into an authorization request message to generate an enhanced authorization request message, and transmit the enhanced authorization request message to an issuer computing device.

### BACKGROUND

The present application relates generally to enhanced data messaging systems and methods for authenticating an identity of an online user over an electronic network, and more particularly, to a network-based system and method for generating and transmitting an enhanced data message that provides identity insights into an online user for authenticating the identity of the online user to a third-party that may not have access to such identity data.

The need to authenticate online users before providing such online users with numerous different online services and/or confidential data is extremely important. For example, online transactions conducted over electronic payment networks are growing exponentially. For card-not-present transactions (e.g., online transactions in which the consumer does not actually provide a payment card to the merchant), fraud is markedly higher. Accordingly, for such transactions, authentication procedures are often implemented to verify that the alleged cardholder is, in fact, the actual or legitimate cardholder. In many cases, certain parties involved in the online transaction either do not have access to certain data that may be used to help authenticate the true identity of the online user or have access to only limited data. Thus, these parties are at a significant disadvantage when trying to authenticate the true identity of the online user prior to completing the purchase transaction.

In at least some known authentication systems, the bank that issued the payment card used to initiate the transaction (referred to as the issuer) contracts with an access control server (ACS) for authentication services. Specifically, the ACS analyzes at least some of the transaction data associated with the transaction, determines whether or not it is likely that the alleged cardholder is, in fact, the actual or legitimate cardholder, and reports that determination to the issuer. In these known cases, the transaction data being analyzed does not include actual identity data of the cardholder, but rather, the data being analyzed is meta data associated with the device or the actual online transaction.

Contracting with an ACS for authentication services may be relatively expensive for an issuer. Further, different issuers may contract with different ACSs. Accordingly, the amount of data that a particular ACS is able to leverage when performing authentication services may be fairly limited, as that ACS may only have access to a relatively small number of transactions. Accordingly, the ACS would not be able to build and apply identity insights of the purchaser for online transactions. Thus, the ACS would not be able to provide the identity insights in line with a transaction as the transaction is being processed. Further, at least some ACSs do not have the capability to perform more sophisticated (and thus more accurate) authentication procedures. In addition, ACSs that are able to provide some level of fraud detection capability may temporarily lose such capability (e.g., due to equipment malfunction), directly impacting their ability to successfully authenticate online users.

Some authentication systems may also implement strong consumer authentication (SCA) (or just “strong authentication”) for certain transactions. For example, an issuing bank may insist on authenticating consumers during online transactions (e.g., with a username and password, or by SMS text message). Such tools may help issuers verify identity and authenticate cardholders, but they may also increase friction with the cardholders, which sometimes leads to transactions being abandoned. This can result in losses to the merchant and to the underlying payment card network. Further, some SCA methods such as passwords may be less trustworthy than others, which may lead to increased risk in transactions. Furthermore, these SCA methods do not include personal identity validation of the online user using an identity engine.

In some markets, regulators may require SCA on digital transactions. For example, the Reserve Bank of India (RBI), India's central bank, requires that all digital transactions are authenticated using SCA. While these regulations have reduced fraud in India, they create considerable friction during the check-out experience. Cardholders get frustrated with having to provide a password or being timed out of the transaction, and merchants are dissatisfied when cardholders abandon transactions due to their frustrations.

Accordingly, it is desirable to have a computer-implemented authentication platform that is capable of performing sophisticated authentication services including providing identity insights that help to identify and validate the online user.

### BRIEF DESCRIPTION

In one aspect, an authentication platform for authenticating an online user is provided. The authentication platform includes a memory device and at least one processor coupled to the memory device. The at least one processor is programmed to generate an authentication model using historical data, the historical data comprising at least historical consumer identity data. The at least one processor is further configured to receive, from a merchant computing device, an authentication request message for a current transaction. The authentication request message includes consumer identity data for the current transaction. The at least one processor is further configured to extract the consumer identity data from the authentication request message and generate, based at least in part on the extracted consumer identity data, identity insight result data including an identity score. The identity insight result data is generated using the authentication model. The at least one processor is further configured to inject the identity insight result data into an authorization request message to generate an enhanced authorization request message and transmit the enhanced authorization request message to an issuer computing device.

In another aspect, a computer-implemented method for authenticating an online user is provided. The method is implemented on a computing device comprising a memory device coupled to at least one processor. The method includes generating an authentication model using historical data, the historical data comprising at least historical consumer identity data. The method further includes receiving, from a merchant computing device, an authentication request message for a current transaction, the authentication request message including consumer identity data for the current transaction and extracting the consumer identity data from the authentication request message. The method further includes generating, based at least in part on the extracted consumer identity data, identity insight result data including an identity score. The identity insight result data is generated using the authentication model. The method further includes injecting the identity insight result data into an authorization request message to generate an enhanced authorization request message and transmitting the enhanced authorization request message to an issuer computing device.

In a further aspect, at least one non-transitory computer-readable storage media having computer-executable instructions embodied thereon for authenticating an online user is provided. When executed by at least one processor, the computer-executable instructions cause the at least one processor to generate an authentication model using historical data, the historical data comprising at least historical consumer identity data. The computer-executable instructions further cause the at least one processor to receive, from a merchant computing device, an authentication request message for a current transaction. The authentication request message including consumer identity data for the current transaction. The computer-executable instructions further cause the at least one processor to extract the consumer identity data from the authentication request message and generate, based at least in part on the extracted consumer identity data, identity insight result data including an identity score. The identity insight result data is generated using the authentication model. The computer-executable instructions further cause the at least one processor to inject the identity insight result data into an authorization request message to generate an enhanced authorization request message and transmit the enhanced authorization request message to an issuer computing device.

### BRIEF DESCRIPTION OF THE DRAWINGS

FIGS. 1-12 show example embodiments of the methods and systems described herein.

FIG. 1 is a schematic diagram illustrating an example authentication platform in communication with a multi-party payment card system for processing payment transactions in accordance with one embodiment of the present disclosure.

FIG. 2 is an expanded block diagram of an example embodiment of a computer system used in processing payment transactions that includes a server system in accordance with one example embodiment of the present disclosure.

FIG. 3 illustrates an example configuration of a server system such as the server system shown in FIG. 2.

FIG. 4 illustrates an example configuration of a client system shown in FIG. 2.

FIG. 5 is a schematic diagram illustrating transaction flow in an example authentication system.

FIG. 6 is a schematic diagram illustrating transaction flow in another example authentication system that includes the identity insights engine.

FIG. 7 is a data flow diagram showing an example method for authenticating an online user.

FIG. 8 is a data flow diagram of another example method for authenticating an online user.

FIG. 9 is a flow diagram of another example method for authenticating an online user.

FIG. 10 is a flow diagram of a further example method for authenticating an online user.

FIG. 11 is a flow diagram of a further example advanced authentication process for authenticating an online user and for increasing approvals, reducing fraud, and improving consumer experience.

FIG. 12 is a schematic diagram illustrating transaction flow in another example authentication system.

Although specific features of various embodiments may be shown in some drawings and not in others, this is for convenience only. Any feature of any drawing may be referenced and/or claimed in combination with any feature of any other drawing.

### DETAILED DESCRIPTION

The systems and methods described herein are directed to generating identity insight data and providing this data to an issuer within an authorization request message while the transaction is being processed to help the issuer determine whether to authorize the transaction after authenticating the purchaser as the legitimate cardholder. In some cases, as explained below, the identity insight data may also be provided to an ACS through an enhanced authentication message to help the ACS in authenticating the online user. The systems and methods described herein include an identity insights enabled directory server that receives an authentication request message for a transaction initiated by an accountholder or cardholder. The authentication request message includes authentication data that includes (i) digital transaction data and (ii) consumer identity data that may be provided to the directory server by the merchant or on behalf of the merchant. The consumer identity data may be captured by the merchant when the consumer or purchaser enters their information into a webpage or mobile app of the merchant to make a purchase. For example, the consumer identity data may include a first and last name of the consumer or purchaser, an email address, a phone number, a mailing address, and an IP (Internet Protocol) address for the device used to access the merchant website or the mobile app and initiate the purchase. This data may be collected as part of an e-commerce transaction via the EMV® 3-D Secure protocol. The merchant environment collects this rich EMV® 3-D Secure data, and then transmits it to the payment processor for identity insights processing.

After receiving this consumer identity data, the identity insights enabled directory server generates, based at least in part on the extracted consumer identity data which is compared to stored cardholder profile data, identity insights result data that includes an identity score and reason codes for explaining the basis for the generated score. The identity insight result data, namely the identity score and reason codes, are then injected into an authorization request message (e.g., an ISO 8583 or ISO 20022 compliant message in Date Element 48 and Sub Element 56) to generate an enhanced authorization request message. The enhanced authorization request message is transmitted to the issuer to enable the issuer to make an authentication decision based on the identity insights result data. Other known authentication systems are unable to generate and provide the identity insight result data within an authorization request message.

As described below, the authorization message is in an ISO 8583 or ISO 20022 message format for processing over a dedicated payment processing network. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

In some embodiments, the identity insights directory server may be configured to authenticate an online user using the consumer identity data while the issuer and/or the ACS may further authenticate the purchaser/consumer based in part on the digital transaction data. An identity insights enabled directory server stores cardholder profile data which may include previously authenticated identity data of a user (e.g., cardholder identity reference data) and rules for performing, scoring, and routing the identity insight results data. The identity insights enabled directory server receives an authentication request message for a transaction. The authentication request message includes consumer identity data along with digital transaction data. The identity insights enabled directory server extracts the consumer identity data from the authentication request message, and compares it to the cardholder identity reference data to confirm or invalidate the identity of the purchaser. The directory server then scores the transaction and generates reasons codes based on the comparison and the rules stored in the cardholder profile data. The issuer and/or the ACS and/or the payment processor may then analyze the digital transaction data to further score the transaction. In some cases, the identity score and reason codes may also be provided to the ACS in an enhanced authentication message along with the digital transaction data so that both data signals (digital transaction data and identity data) may be used to determine whether to authenticate the purchaser.

As noted above, in at least some known authentication systems, a bank that issued a payment card for a transaction (referred to as the issuer) may contract with an ACS for authentication services relating to analyzing digital transaction data. Specifically, the ACS analyzes at least some of the digital transaction data associated with the transaction, determines whether or not it is likely that the alleged cardholder is, in fact, the actual or legitimate cardholder, and reports that determination to the issuer. However, this analysis is not based on the identity of the cardholder. Rather, it is based on some of the metadata associated with the online transaction. Thus, this digital transaction data analysis is quite different from the identity insight analysis described herein.

Accordingly, to address these limitations of known authentication systems, the systems and methods described herein include an identity insight engine that is configured to authenticate an online purchaser as the legitimate cardholder (or alternatively indicate when the online purchaser is not the legitimate cardholder and is a fraudster). The identity insight engine is configured to specifically address cross-border identity fraud (e.g., when a person is using identity data elements in a fraudulent way in different geographic regions), synthetic identity fraud (e.g., when legitimate data from multiple cardholders is combined together to create a new fraudulent identity), and stolen identity fraud (e.g., when legitimate data from a single cardholder is stolen and used by a fraudster).

As described herein, identity insights refer to performing authentication on online payment transactions using a rich, comprehensive data set that is generally not available to an issuer or ACS. For example, as described herein, identity insights may include performing authentication using the 3DS2 Protocol (for example versions 2.0, 2.1, 2.2, and subsequent versions of the 3DS Protocol). The 3DS Protocols are owned and updated by EMVCo. Further, as described herein, the identity insights engine may be part of an authentication platform that is operated by the payment processing network. Thus, for authentication purposes, the authentication platform is capable of leveraging large volumes of historical consumer identity data and digital interaction data from various data sources, as well as transaction data previously processed by the payment processing network (as compared to the relatively small number of transactions processed by a particular ACS). The identity insight engine may be further configured to build and store cardholder profile data to be used for comparing to the consumer identity data captured as part of the payment transaction to determine whether the purchaser is the legitimate cardholder. The cardholder profile data is a unique data structure of historical identity data used by a particular cardholder over time. These profiles are generated for each legitimate cardholder and stored in memory so that they can later be used to be compared to the received identity data for a particular transaction to then determine whether the received identity data matches one or more records of previous identity data used in the transaction. The payment processor processes many transactions for a cardholder, and therefore the identity insight engine is able to build a robust cardholder profile for making the identity determination.

Specifically, in the systems and methods described herein, the authentication system uses the 3DS2 Protocol (or subsequent versions of the 3DS Protocol) for capturing data to be used for authentication purposes, and performs identity insights using the identity insights engine to authenticate the identity of the purchaser. The identity insights enabled directory server is communicatively coupled to the identity insights engine (which may be collectively referred to as an authentication platform). The identity insights enabled directory server and the identity insights engine facilitate performing identity insights on behalf of the issuer. The identity insights enabled directory server and the identity insights engine may be operated, for example, by an interchange network (e.g., a payment processing network).

More specifically, the identity insights enabled directory server receives an authentication request (AReq) message from a 3DS server. The AReq includes authentication data that includes both digital transaction data, and consumer identity data that may be provided to the directory server by the merchant or on behalf of the merchant. The consumer identity data may be captured for example by the merchant when the consumer or purchaser enters their information into a webpage or mobile app of the merchant to make a purchase. For example, the consumer identity data may include a first and last name of the consumer or purchaser, an email address, a phone number, a mailing address, and an IP (Internet Protocol) address for the device used to access the merchant website and initiate the purchase. This data may be collected as part of an e-commerce transaction using the 3DS2 protocol. The merchant environment collects this rich 3DS2 data, and then transmits it to the payment processor for identity insights processing.

After receiving this consumer identity data and building the cardholder profiles that include authoritative identity data (e.g., reference data) for each cardholder that has been previously used successfully by the cardholder, the identity insights enabled directory server generates, based at least in part on the extracted consumer identity data which is compared to stored cardholder profile data, identity insights result data that includes an identity score and reason codes for explaining the basis for the generated score. The identity insight result data, namely the identity score and reason codes, is then injected into an authorization request message (e.g., an ISO 8583 or ISO 20022 compliant message in Date Element 48 and Sub Element 56) to generate an enhanced authorization request message. The enhanced authorization request message is transmitted to the issuer to enable the issuer to make an authentication decision (and ultimately an authorization decision) based on the identity insights result data.

In the example embodiment, the identity insights result data generated by the identity insights engine includes an identity score (or risk score at position 1 of DE 48.56 sub-field 2) and at least one reason code (e.g., value A-Z at position 2 and value A-Z at position 3). Sub-field 1 may include an alpha-numeric indicator that indicates that the identity insights result data is inserted in sub-field 2. The identity score is a score representing a determined likelihood that the consumer identity is fraudulent, with lower scores indicating a likelihood that the consumer identity is genuine and higher scores indicating the consumer identity is fraudulent. In other words, the identity score represents a likelihood that the suspect cardholder (e.g., the person attempting to perform a transaction) is the legitimate cardholder having the privileges to use the payment card to perform a payment transaction. For example, the identity score may be represented by a number from 0-999, or 0-500, and/or by an identity threshold category from 0-9. Those of skill in the art will appreciate that any suitable identity score may be used.

The identity score and/or the reason codes and/or the particular combination of reason codes may be associated with a severity level. The reason codes include one or more factors that influenced the identity score. In some embodiments, the reason codes are generated based on anchors, as described herein. In some embodiments, the reason codes are affected by rules, the model, and/or a combination of the rules and the model. The identity insights engine transmits the identity insights result data to the identity insights enabled directory server.

The identity insights enabled directory server injects the identity insights result data into the authorization request message to generate an enhanced or enriched authorization message. For example, in some embodiments, the identity insights result data is appended to the authorization request message as an extensible markup language (XML) extension of the authorization message. For example, the extension may have the following format:

```
“name”: “DII”,
“id”: “A000000004-DII”,
“criticalityIndicator”: “true”,
“data”: {
  “status”:“success”,
  “score”:“1”,
  “decision”:“low severity”,
    “reasonCode1”:“R”,
  “reasonCode2”:“D”}
```

where “score” is the identity score, “decision” is the fraud likelihood level, and “reasonCode1” and “reasonCode2” are the reason codes. In the exemplary embodiment, the reason codes are transmitted as a single letter each. In other embodiments, the reason codes may be represented in different methods. In some embodiments, the identity insights result data may be injected into the authorization message to generate an enhanced or enriched authorization request message using any suitable process.

In another embodiment, the reason codes may include or indicate high severity, medium severity and low severity. For example, the reason codes for high severity may include the following:

| Code | Severity Level | Description |
|---|---|---|
| AA | High | Consumer Identity is suspicious |
| AB | High | Increased Risk associated with Email |
| AC | High | Increased Risk associated with Email & IP |
| AD | High | Increased Risk associated with Email & Address |
| AE | High | Increased Risk associated with Email & Phone |
| AF | High | Increased Risk associated with Email & Name |
| AG | High | Increased Risk associated with IP |
| AH | High | Increased Risk associated with IP & Phone |
| AI | High | Increased Risk associated with IP & Address |
| AJ | High | Increased Risk associated with IP & Name |
| AK | High | Increased Risk associated with Address |
| AL | High | Increased Risk associated with Address & Phone |
| AM | High | Increased Risk associated with Address & Name |
| AN | High | Increased Risk associated with Name |
| AO | High | Increased Risk associated with Name & Phone |
| AP | High | Increased Risk associated with Phone |

The reason codes for medium severity may include the following:

| Code | Severity Level | Description |
|---|---|---|
| JA | Medium | New Consumer or not sufficient information |
| JB | Medium | Medium Risk Signals associated with Email |
| JC | Medium | Medium Risk Signals associated with Address |
| JD | Medium | Medium Risk Signals associated with Phone |
| JE | Medium | Medium Risk Signals associated with Name |
| JF | Medium | Medium Risk Signals associated with IP |

The reason codes for low severity may include the following:

| | Severity | |
|---|---|---|
| Code | Level | Description |
| RA | Low | Consumer Trust Established across all PII elements |
| RB | Low | Established Credibility for Email |
| RC | Low | Established Credibility for Email & IP |
| RD | Low | Established Credibility for Email & Address |
| RE | Low | Established Credibility for Email & Phone |
| RF | Low | Established Credibility for Email & Name |
| RG | Low | Established Credibility for IP |
| RH | Low | Established Credibility for IP & Phone |
| RI | Low | Established Credibility for IP & Address |
| RJ | Low | Established Credibility for IP & Name |
| RK | Low | Established Credibility for Address |
| RL | Low | Established Credibility for Address & Phone |
| RM | Low | Established Credibility for Address & Name |
| RN | Low | Established Credibility for Name |
| RO | Low | Established Credibility for Name & Phone |
| RP | Low | Established Credibility for Phone |
| RP | Low | Established Credibility for Phone |

The enhanced authorization request message is then transmitted from the identity insights enabled directory server to the issuer. The issuer then analyzes the identity insights result data in the enhanced message to make an authentication decision (and an authorization decision). That is, in the example embodiment, the issuer may determine to fully authenticate the transaction, deny authentication for the transaction, or perform additional authentication (e.g., by issuing a step-up challenge possibly via the ACS to the cardholder) for the transaction, based on at least one of an identity score, the fraud likelihood level, and the reason codes. Accordingly, the issuer does not perform the identity insights analysis, but is still able to leverage the results of that analysis to make an authentication decision (e.g., by using the results in their own fraud analysis platform), generally resulting in more approvals with less fraud.

In the example embodiment, the authentication platform compares the identity insights result data to a stored authorization profile. The authorization profile contains a plurality of rules for the processing of authentication requests. In some embodiments, the authorization profile is provided by an issuer computing device associated with an issuer bank. Examples of the rules include, but are not limited to, information to include in the identity insights assessment, severity level thresholds for the identity score and severity levels, decision making severity thresholds, and specialized rules (such as all cross-border transactions are to be submitted to the ACS). The authorization profile is stored at the authentication platform, and can be accessed whenever an identity score is determined.

In the example embodiment, the authentication platform compares the identity insights result data to the authorization profile to determine the severity level associated with the transaction associated with the authentication request. In some embodiments, the authentication platform compares the identity score to one or more thresholds in the authorization profile to determine the severity level associated with the transaction. In other embodiments, the authentication platform compares the identity score, the fraud likelihood level, the reason codes, and/or any other combination of data from the identity insights result data and potentially some or all of the authentication data to the authorization profile to determine the likelihood of the identity associated with this transaction being fraudulent. For example, for identity insight assessment assessed on a scale from 0-9, an identity score of 3 or less may be considered low severity, an identity score between 4 and 7 may be considered medium severity, and an identity score above 8 may be considered high severity. Those skilled in the art will appreciate that any suitable identity score thresholds and any number of severity levels may be used. The issuer leverage the results of identity insights analysis to make an authentication decision (e.g., by using the results in their own fraud analysis platform).

In some embodiments, the authentication platform generates an authentication decision based on the identity insights result data. For example, in the case of a high-severity transaction, the authentication platform may deny the transaction. The authentication platform may transmit an authentication response (ARes) message including the denial to the 3DS server. The 3DS server may transmit the ARes message including the denial to the merchant, where the merchant determines whether or not to proceed with the authorization process. In these embodiments, where the merchant begins the authorization process after having received a denial, the transaction is considered to be merchant only authentication, where the merchant assumes the risk for the transaction. In the case of a medium severity or low severity. If the transaction is low severity, the authentication platform may approve the transaction and transmit an authentication response (ARes) message including the approval to the 3DS server, where at least one of the 3DS server and the merchant may initiate the authorization process. If the transaction is medium severity, the authentication platform may issue a step-up challenge to the cardholder. Based on the results of the step-up challenge, the authentication platform may approve or deny the transaction. In some embodiments, if the transaction is medium severity, the authentication platform transmits the identity insights result data to the ACS via an enhanced authentication message (where both the identity insight data and the digital transaction data can be provided to the ACS), so that the ACS will perform the step-up challenge. In other embodiments, the authentication platform may take different steps at different severity levels and have additional or fewer severity levels to analyze based on the authorization profile.

The 3DS2 Protocol (and subsequent versions of the 3DS Protocol) provides a number of benefits to cardholders, issuers, and merchants. It reduces transactions associated with identity fraud through an approach that incorporates a rich, comprehensive set of data to make authentication decisions. For cardholders, it provides a simple, secure, and familiar online authentication experience, regardless of payment channel or device. For issuers, it allows for “frictionless” authentication, in which an explicit cardholder step-up authentication is not required or performed. This enables more intelligent identity assessment decisions and the ability to selectively challenge the cardholder as needed. This also improves cardholder experience and overall cardholder loyalty to issuers. For merchants, the 3DS2 Protocol decreases fraud on all authenticated transactions, and increases revenue potential from reduced friction and reduced cart abandonment (i.e., cardholders deciding not to complete a transaction after they have already selected one or more items to be purchased), especially for mobile payment channels. This also improves cardholder experience and overall cardholder loyalty to merchants. The 3DS2 Protocol may support additional payment channels, such as, but not limited to, card-on-file, wallet, mobile, in-app, and Internet of Things (IoT).

Using 3DS2 Protocol (or subsequent versions of the 3DS Protocol), payment networks see 100% of all authentication requests globally on all cards on their brands. No other party, including issuers and ACS providers, is able to provide this global visibility. This global visibility may be leveraged to provide a consistent, standards-based analysis of consumer identities in transactions on behalf of issuers, enabling a marketwide identity-based authentication approach.

As discussed above, the identity insight engine is able to build a robust cardholder profile for making an identity determination. In some cases, identity insights compares over 2 billion identities and over 5 billion digital interactions to validate whether a consumer initiating a transaction is genuine or not. Assessing this data in the 3DS Protocol increases data exchange between merchants and issuers, and improves authentication decisioning. Identity insights allows issuers to examine every authentication request through an identity analysis, while focusing fraud prevention efforts on preventing fraudulent identities. Further, identity insights utilizes consumer identity data inputs in conjunction with an identity insights engine to determine the likelihood of a fraudulent identity being used in a transaction. The identity insights method of cardholder authentication dynamically calculates an identity insights assessment for any given e-commerce transaction in real time. The assessment can then be used to authenticate the cardholder identity in a frictionless manner.

Issuers and payment processors must differentiate between genuine cardholders and identity fraud. Identity fraud may take various forms. In some instances, identity fraud comprises stolen identity, in which someone wrongfully obtains and uses another person's personal data (e.g., name, account number, etc.) in some way that involves fraud or deception, typically for economic gain. In other instances, identity fraud comprises synthetic identity, in which a real person's information (e.g., name, account number etc.) is wrongfully obtained and combined with other personal information, either falsified or from another person), to create a new identity. In yet other instances, identity fraud comprises cross-border identity fraud, in which a person is using identity elements in a fraudulent way in different regions (e.g., the United States and Europe).

An example of a transaction with a genuine consumer identity may include, where two or more consumer identity data elements (e.g., name, phone number, email, billing address, shipping address, and/or IP address) have been seen together online, the consumer email address has been in use for a long period of time (e.g., a year or more), the IP address is located within a certain radius of the provided shipping and/or billing address, and/or there is established credibility for the IP address. An example of a medium severity transaction may include, where the cardholder is using an unknown device with no known association with the cardholder, the device is at a non-typical geolocation and IP address, but other consumer identity data elements have been seen together before. For example, the cardholder is on travel and purchases Internet Access at a hotel, the IP address may be far away from the billing address, but the other consumer identity data elements, such as name, email, phone number, and billing address have been seen used together in previous transactions. An example of a high-severity transaction may include, where there is a suspicious combination of identity data elements, the email address was recently created, the IP address is thousands of miles from the billing and/or shipping address, and/or the IP address has been linked to fraudulent transactions. For example, the cardholder have a name and phone number that have never been seen together before online.

One goal of identity insights is to minimize the number of transactions that require active (i.e., step-up) authentication, while keeping fraud to a minimum and improving consumer friction points during the transaction process. The goal of identity insights is to silently eliminate unnecessary friction on low-severity transactions. With identity insights, the information gathered enables identity scoring and classification into low, medium, and high severity, allowing the issuer and/or ACS to take appropriate action.

The 3DS2 Protocol (and subsequent versions of the 3DS Protocol) enables a marketwide level identity fraud analysis of all transactions that reach directory server. Each transaction can be scored and/or flagged based on the global data available using the 3DS2 Protocol (and subsequent versions of the 3DS Protocol). Additionally, the payment processor operating the directory server has the ability to see cardholder activity across the digital and physical domains, and can utilize this expanded view to improve scoring. In contrast, traditional authentication service providers may only address the digital domain. For example, a payment processor could indicate if a particular device is associated with fraud, and flag that device for issuers in future transactions. The issuer may then reject transactions involving that device or prompt for additional authentication (e.g., through two-factor authentication).

The following Table 1 lists a number of the data elements that are used in the 3DS2 Protocol for authentication. For example, at least some of these data elements may be included in the authentication data included in the AReq sent to directory server. The eighteen data elements that are also part of the 3DS 1.0 Protocol are bolded in Table 1. Those of skill in the art will appreciate that the number of rich data elements could grow beyond those listed below (e.g., in future versions of the 3DS Protocol), and could include over one hundred and seventy data elements. Further, an app-based transaction (e.g., carried out using a mobile computing device) could provide even more data elements than browser-based transactions. In addition, a transaction performed using an Android device could have over one hundred and thirty additional elements. The authentication data may also be divided by category, such as: transaction data (amount, currency, date, and time), device data (IP address, device info, and channel data), cardholder data (account number and shipping address), and merchant data (name, category, and country).

TABLE 1

| | Data Element |
|---|---|
| 1 | 3DS Requestor Authentication Information |
| 2 | 3DS Requestor Challenge Indicator |
| 3 | 3DS Requestor ID |
| 4 | 3DS Requestor Initiated Indicator |
| 5 | 3DS Requestor Name |
| 6 | 3DS Requestor Non-Payment Authentication Indicator |
| 7 | 3DS Requestor Prior Transaction Authentication |
| | Information |
| 8 | 3DS Requestor URL |
| 9 | 3DS Server Operator ID |
| 10 | 3DS Server Reference Number |
| 11 | 3DS Server Transaction ID |
| 12 | 3DS Server URL |
| 13 | Account Type |
| 14 | Acquirer BIN |
| 15 | Acquirer Merchant ID |
| 16 | ACS Challenge Mandated Indicator |
| 17 | ACS Counter ACS to SDK |
| 18 | ACS HTML |
| 19 | ACS Operator ID |
| 20 | ACS Reference Number |
| 21 | ACS Rendering Type |
| 22 | ACS Signed Content |
| 23 | ACS Transaction ID |
| 24 | ACS UI Type |
| 25 | Address Match Indicator |
| 26 | Authentication Method |
| 27 | Authentication Type |
| 28 | Authentication Value |
| 29 | Browser Accept Headers |
| 30 | Browser IP Address |
| 31 | Browser Java Enabled |
| 32 | Browser Language |
| 33 | Browser Screen Color Depth |
| 34 | Browser Screen Height |
| 35 | Browser Screen Width |
| 36 | Browser Time Zone |
| 37 | Browser User-Agent |
| 38 | Card/Token Expiry Date |
| 39 | Cardholder Account Identifier |
| 40 | Cardholder Account Information |
| 41 | Cardholder Account Number |
| 42 | Cardholder Billing Address City |
| 43 | Cardholder Billing Address Country |
| 44 | Cardholder Billing Address Line 1 |
| 45 | Cardholder Billing Address Line 2 |
| 46 | Cardholder Billing Address Line 3 |
| 47 | Cardholder Billing Address Postal Code |
| 48 | Cardholder Billing Address State |
| 49 | Cardholder Email Address |
| 50 | Cardholder Home Phone Number |
| 51 | Cardholder Mobile Phone Number |
| 52 | Cardholder Name |
| 53 | Cardholder Shipping Address City |
| 54 | Cardholder Shipping Address Country |
| 55 | Cardholder Shipping Address Line 1 |
| 56 | Cardholder Shipping Address Line 2 |
| 57 | Cardholder Shipping Address Line 3 |
| 58 | Cardholder Shipping Address Postal Code |
| 59 | Cardholder Shipping Address State |
| 60 | Cardholder Work Phone Number |
| 61 | Challenge Additional Information Text |
| 62 | Challenge Cancelation Indicator |
| 63 | Challenge Data Entry |
| 64 | Challenge HTML Data Entry |
| 65 | Challenge Information Header |
| 66 | Challenge Information Label |
| 67 | Challenge Information Text |
| 68 | Challenge Information Text Indicator |
| 69 | Challenge Selection Information |
| 70 | Challenge Window Size |
| 71 | Device Channel |
| 72 | Device Information |
| 73 | Device Rendering Options Supported |
| 74 | DS Reference Number |
| 75 | DS Transaction ID |
| 76 | DS URL |
| 77 | Electronic Commerce Indicator |
| 78 | EMV Payment Token Indicator |
| 79 | Expandable Information Label 1 |
| 80 | Expandable Information Text 1 |
| 81 | Instalment Payment Data |
| 82 | Interaction Counter |
| 83 | Issuer Image |
| 84 | Merchant Category Code |
| 85 | Merchant Country Code |
| 86 | Merchant Name |
| 87 | Merchant Risk Indicator |
| 88 | Message Category |
| 89 | Message Extension |
| 90 | Message Type |
| 91 | Message Version Number |
| 92 | Notification URL |
| 93 | OOB App Label |
| 94 | OOB App URL |
| 95 | OOB Continuation Indicator |
| 96 | OOB Continuation Label |
| 97 | Payment System Image |
| 98 | Purchase Amount |
| 99 | Purchase Currency |
| 100 | Purchase Currency Exponent |
| 101 | Purchase Date & Time |
| 102 | Recurring Expiry |
| 103 | Recurring Frequency |
| 104 | Resend Challenge Information Code |
| 105 | Resend Information Label |
| 106 | Results Message Status |
| 107 | SDK App ID |
| 108 | SDK Counter SDK to ACS |
| 109 | SDK Encrypted Data |
| 110 | SDK Ephemeral Public Key (Qc) |
| 111 | SDK Reference Number |
| 112 | SDK Transaction ID |
| 113 | Submit Authentication Label |
| 114 | Transaction Status |
| 115 | Transaction Status Reason |
| 116 | Transaction Type |
| 117 | Why Information Label |
| 118 | Why Information Text |

In some embodiments, the authentication platform performs the authentication process on the transaction, including identity insights assessment. This analysis is based on a machine learning model where, over time, the authentication platform is capable of improving its ability to determine identity fraud in transactions. In some embodiments, the authentication platform may be configured to retrieve historical data and compile the historical data to build a historical identity record. The authentication platform may store the historical identity record within a database for later use. The historical identity data may comprise cardholder profile data elements (e.g., name, email address, phone number, IP address, billing address, shipping address, etc.).

The authentication platform may retrieve a plurality of historical identity records from the database to build a training dataset. The training dataset may be used to train an identity insights model. The identity insights model may be generated and/or trained using the training database using any suitable analysis and/or statistic technique. In some embodiments, the identity insights model may include a plurality of model parameters for comparing individual parameters to determined parameters, as described herein. In other embodiments, the identity insights model may be in a different form, such as a function or a set of functions. In some embodiments, the identity insights model leverages one or more clustering algorithms.

The authentication platform analyzes transactions that are authenticated by the issuer and/or ACS and the identity insights model compares these transactions with historical data to generate an identity insights model for each issuer and/or ACS. By comparing the data points in each transaction, the identity insights model will indicate the likelihood of identity fraud associated with each transaction based on the consumer profile data in the corresponding authentication requests. This allows the authentication platform to authenticate a purchaser/consumer based in part on the identity insights analysis. Accordingly, the authentication platform may determine that a received authorization request is substantially similar to a previous transaction that the issuer approved. Thus, allowing the authentication platform to determine that the received transaction has a low likelihood of identity fraud.

The authentication platform may update the training set by creating one or more new historical identity records. In particular, the authentication platform may generate new historic event records in response to outcomes, and the authentication platform may add the newly generated historical event records to the training dataset to generate an updated dataset. Subsequently, the authentication platform may re-train the identity insights model using the updated training dataset, further improving the accuracy of the identity insights model.

At least one of the technical problems addressed by this system includes: (i) high network load based at least in part on step-up challenging most or all card-not-present transactions which results in network delays and reduced bandwidth: (ii) allowing fraudulent transactions to be successfully processed if there is no step-up challenge of a card-not-present transaction: (iii) consumer inconvenience during card-not-present transactions based at least in part on having to answer an additional authentication challenge during a transaction: (iv) abandonment of transactions by consumers when faced with a step-up challenge, thus leading to lost sales for merchants and lost processing fees for the other network parties based on those abandoned transactions: (v) unavailability of customizable fraud-related services to merchants and/or merchant acquirers: (vi) increased risk with merchant liability for fraudulent transactions: (vii) digital wallet-related fraud: (viii) issuers having limited access to some data that may be used to fraud-score transactions: (ix) reducing the network load by reducing network traffic to and from the ACS: (x) increasing the speed of the authentication process by reducing the number of steps required: (xi) reducing the processing load of the ACS by pre-filtering authentication requests to prevent redundant or unnecessary processing; and (xii) improved transaction approval rates.

A technical effect of the systems and processes described herein is achieved by performing at least one of the following steps: (i) generating an authentication model using historical data, the historical data comprising at least historical consumer identity data: (ii) receiving, from a merchant computing device, an authentication request message for a current transaction, the authentication request message including consumer identity data for the current transaction: (iii) extracting the consumer identity data from the authentication request message: (iv) generating, based at least in part on the extracted consumer identity data, identity insight result data including an identity score, the identity insight result data generated using the authentication model: (v) injecting the identity insight result data into an authorization request message to generate an enhanced authorization request message; and (vi) transmitting the enhanced authorization request message to an issuer computing device.

In some embodiments, a further technical effect is achieved by performing at least one of the following steps: (i) generating an authentication model using historical data, the historical data comprising at least historical consumer identity data: (ii) receiving, from a merchant computing device, an authentication request message for a current transaction, the authentication request message including consumer identity data for the current transaction: (iii) extracting the consumer identity data from the authentication request message: (iv) generating, based at least in part on the extracted consumer identity data, identity insight result data including an identity score, the identity insight result data generated using the authentication model: (v) injecting the identity insight result data into an authentication request message to generate an enhanced authentication request message; and (vi) transmitting the enhanced authentication request message to an access control server (ACS).

As will be appreciated, based on the description herein the technical improvement in the authentication system as described herein is a computer-based solution to a technical deficiency or problem that is itself rooted in computer technology (e.g., the problem itself derives from the use of computer technology). More specifically, fraud is significant problem for transactions conducted over an electronic payment network, especially for card-not-present transactions. Advanced fraud detection methodologies exist, but at least some ACSs are unable to execute those methodologies and furthermore communication with ACSs increases network traffic and processing load, and in addition the ACS may be unavailable. Accordingly, to address this problem, the systems and methods described herein address this technical problem by using an identity insights directory server and identity insights engine to perform an identity insights assessment and filter the results to determine which authentications need to be forwarded to an ACS and to forward the results of the identity insights analysis to the ACS to enable the ACS to make an authentication decision.

The following detailed description of the embodiments of the disclosure refers to the accompanying drawings. The same reference numbers in different drawings may identify the same or similar elements. Also, the following detailed description does not limit the claims.

Described herein are computer systems such as authentication computer systems. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California: IBM is a registered trademark of International Business Machines Corporation, Armonk, New York: Microsoft is a registered trademark of Microsoft Corporation, Redmond, Washington; and Sy base is a registered trademark of Sybase, Dublin, California.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “payment device,” “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), wearable computing devices, key fobs, and/or any other computing devices capable of providing account information. Moreover, these terms may refer to payments made directly from or using bank accounts, stored valued accounts, mobile wallets, etc., and accordingly are not limited to physical devices but rather refer generally to payment credentials. Each type of payment device can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to authenticating users for transactions conducted over an electronic payment network.

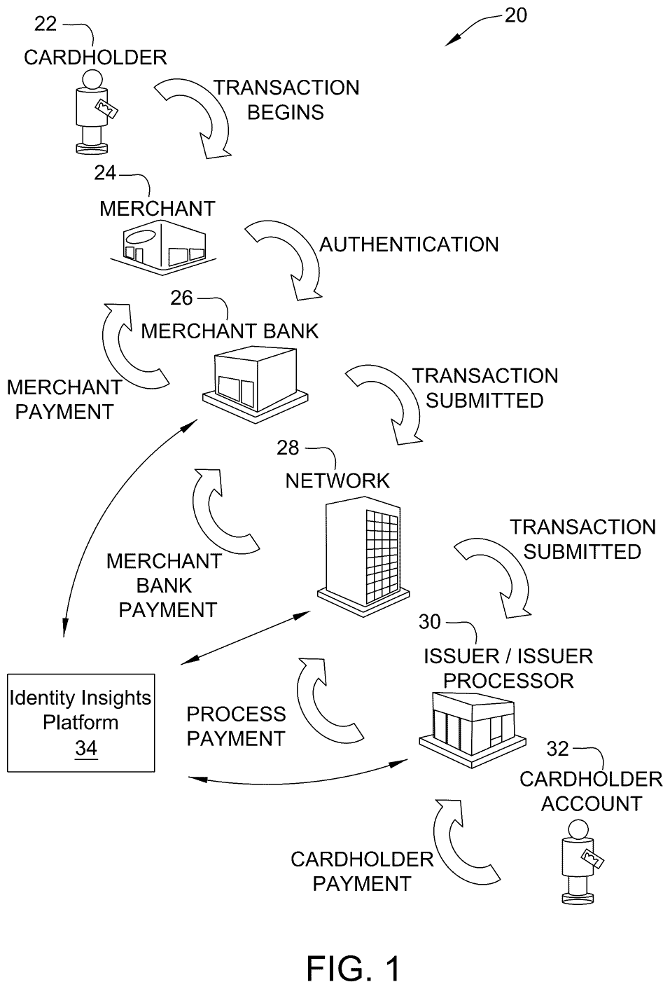

FIG. 1 is a schematic diagram illustrating an example identity insights (authentication) platform 34 in communication with a multi-party payment card system 20 for processing payment transactions in accordance with one embodiment of the present disclosure. FIG. 1 depicts a flow of data in a financial transaction through system 20. Embodiments described herein may relate to a transaction card system, such as a credit card payment system using the MASTERCARD® interchange network. The MASTERCARD® interchange network is a set of proprietary communications standards promulgated by Mastercard International Incorporated® for the exchange of financial transaction data and the settlement of funds between financial institutions that are members of Mastercard International Incorporated®. (MASTERCARD® is a registered trademark of Mastercard International Incorporated located in Purchase, New York).

In the exemplary transaction card system, a financial institution called the “issuer” issues a transaction card, such as a credit card, to a consumer or cardholder 22, who uses the transaction card to tender payment for a purchase from a merchant 24. Cardholder 22 may purchase goods and services (“products”) at merchant 24. Cardholder 22 may make such purchases using virtual forms of the transaction card and, more specifically, by providing data related to the transaction card (e.g., the transaction card number, expiration date, associated postal code, and security code) to initiate transactions. To accept payment with the transaction card or virtual forms of the transaction card, merchant 24 must normally establish an account with a financial institution that is part of the financial payment system. This financial institution is usually called the “merchant bank,” the “acquiring bank,” or the “acquirer.” When cardholder 22 tenders payment for a purchase with a transaction card or virtual transaction card, merchant 24 requests authentication of the cardholder 22 and authorization from a merchant bank 26 for the amount of the purchase. The request may be performed over the telephone or electronically (e.g., via a computer network), but is usually performed through the use of a point-of-sale terminal, a website or a mobile app, which reads cardholder's 22 account information from a magnetic stripe, a chip, or embossed characters on the transaction card (or inputted into the website or mobile app) and communicates electronically with the transaction processing computers of merchant bank 26. Merchant 24 receives cardholder's 22 account information as provided by cardholder 22. Alternatively, merchant bank 26 may authorize a third party to perform transaction processing on its behalf. In this case, the point-of-sale terminal or client computing device will be configured to communicate with the third party. Such a third party is usually called a “merchant processor,” an “acquiring processor,” or a “third party processor.”

Using an interchange network 28, computers of merchant bank 26 or merchant processor will communicate with computers of an issuer bank 30 to determine whether the alleged cardholder is actually legitimate cardholder 22 (i.e., authentication), whether cardholder's 22 account 32 is in good standing, and whether the purchase is covered by cardholder's 22 available credit line. Based on these determinations, the requests for authentication and authorization will be declined or accepted. Authentication may be performed prior to authorization. If the requests are accepted, an authorization code is issued to merchant 24.

In the exemplary embodiment, the payment card system 20 includes or is in communication with an identity insights server 34. In this embodiment, the identity insights (authentication) platform 34 provides enhanced meta-data collection to capture information, including identifying meta-data from the payment transactions processed by the payment card system 20. The identity insights platform 34 stores this meta-data to use as historical data when performing an authentication process prior to performing an authorization process. In the exemplary embodiment, the identity insights platform 34 may receive historical data from one or more of the acquirer bank 26, the interchange network 28, and the issuer bank 30. Examples of this data include one or more long term variables (“LTVs”). The one or more LTVs may include historical consumer identity data, historical digital interaction data, historical authentication data associated with the PAN at issue, historical authorization data associated with the PAN, other historical data associated with the PAN, etc. The LTVs may be associated with both card present and card not present historical transactions. For example, the LTVs may include cardholder shipping address, cardholder billing address, cardholder email address, cardholder name, cardholder phone number, merchant name, merchant category, merchant location, and/or at least one environment-related variable (e.g., device details, browser details) including device ID, IP address, device channel, etc. Further, the LTVs may be stored in a database accessible by authentication platform 34 and operated by an interchange network 28. In some embodiments, the LTV data will be hashed prior to storing to protect the security of this personally identifiable information.

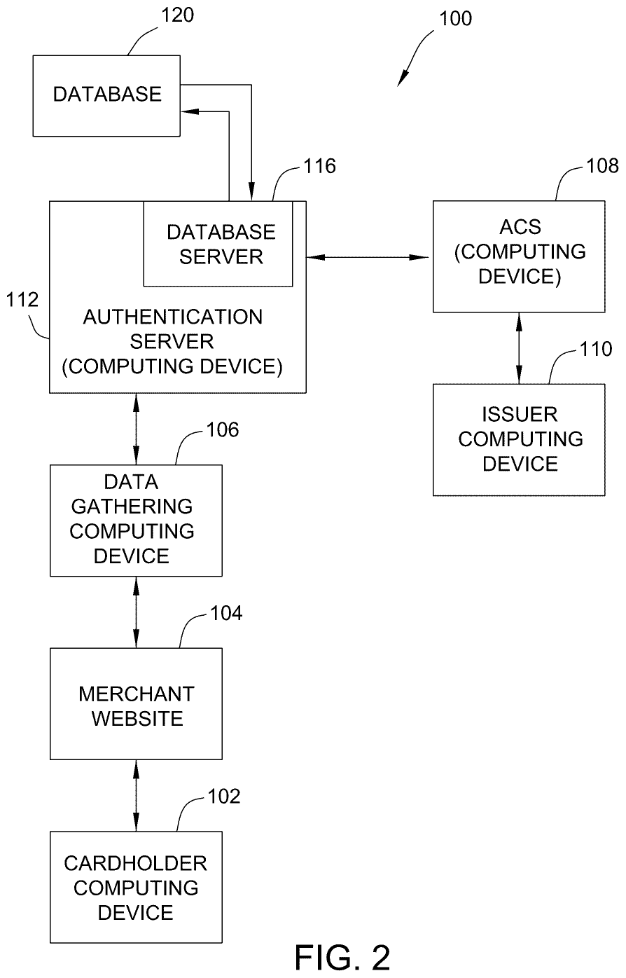

When a request for authorization is accepted, the available credit line of cardholder's 22 account 32 is decreased. Normally, a charge for a payment card transaction is not posted immediately to cardholder's 22 account 32 because bankcard associations, such as Mastercard International Incorporated®, have promulgated rules that do not allow merchant 24 to charge, or “capture,” a transaction until products are shipped or services are delivered. However, with respect to at least some debit card transactions, a charge may be posted at the time of the transaction. When merchant 24 ships or delivers the products or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns products after the transaction has been captured, a “credit” is generated. Interchange network 28 and/or issuer bank 30 stores the transaction information, such as a cardholder name, cardholder email, cardholder phone number, IP address, billing address, and shipping address, in a database 120 (shown in FIG. 2).

After a purchase has been made, a clearing process occurs to transfer additional transaction data related to the purchase among the parties to the transaction, such as merchant bank 26, interchange network 28, and issuer bank 30. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction. After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction may be settled between issuer bank 30 and interchange network 28, and then between interchange network 28 and merchant bank 26, and then between merchant bank 26 and merchant 24.

As described below in more detail, an identity insights check may be performed by the identity insights (authentication) platform 34 on behalf of an access control server (ACS) or issuer bank 30 in the context of multi-party payment card system 20. Although the systems described herein are not intended to be limited to facilitate such applications, the systems are described as such for example purposes.

FIG. 2 is an expanded block diagram of an example embodiment of a computer system 100 used in authenticating payment transactions. In the exemplary embodiment, system 100 may be used for authenticating payment transactions either in concert with an ACS or in place of the ACS.

In the exemplary embodiment, cardholder computing devices 102 are computers that include a web browser or a software application, which enables cardholder computing devices 102 to access remote computer devices, such as merchant website 104, using the Internet or other network. More specifically, cardholder computing devices 102 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Cardholder computing devices 102 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, cardholder computing devices 102 are associated with individual cardholders 22 (shown in FIG. 1).

In the exemplary embodiment, merchant website 104 is an online shopping website that is reachable through computers that include a web browser or a software application, such as cardholder computing devices 102, using the Internet or other network. More specifically, merchant website 104 may be hosted on one or more computers that are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Computing devices hosting merchant website 104 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, merchant website 104 are associated with merchant 24 (shown in FIG. 1). In the exemplary embodiment, merchant website 104 or mobile app allows cardholder 22 to purchase goods and/or services using cardholder computing device 102. In some embodiments, payment transactions performed through merchant website 104 are considered card not present transactions.

In the exemplary embodiment, data gathering computer devices 106 are computers that include a web browser or a software application, which enables data gathering computer devices 106 to access remote computer devices, such as merchant website 104 and authentication server 112, using the Internet or other network. More specifically, data gathering computing devices 106 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Data gathering computer devices 106 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, the data gathering computer devices 106 are associated with a 3DS server or service. In other embodiments, data gathering computer devices 106 are associated with acquirer bank 26 (shown in FIG. 1).

In the exemplary embodiments, authentication server 112 is in communication with a plurality of data gathering computer devices 106 and one or more access control servers (ACS) 108. In some embodiments, authentication server 112 is similar to identity insights (authentication) platform 34 (shown in FIG. 1). In the exemplary embodiment, authentication server 112 receives data from data gathering computer device 106 and uses that data to perform authentication of payment transactions. In some embodiments, authentication server 112 performs authentication with ACS 108. In other embodiments, authentication server 112 replaces the ACS 108 in the authentication process. In the exemplary embodiment, authentication server 112 is associated with the interchange network 28 (shown in FIG. 1). In other embodiments, the authentication server 112 is merely in communication with the interchange network 28.

In the exemplary embodiment, issuer computing devices 110 are computers that include a web browser or a software application, which enables issuer computing devices 110 to access remote computer devices, such as ACS 108 and authentication server 112, using the Internet or other network. More specifically, issuer computing devices 110 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Issuer computing devices 110 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, issuer computing devices 110 are associated with the issuer bank 30 (shown in FIG. 1).

A database server 116 is connected to database 120. In one embodiment, centralized database 120 is stored on server system 112 and can be accessed by potential users at one of client systems (not shown) by logging onto authentication server 112 through one of client systems. In an alternative embodiment, database 120 is stored remotely from authentication server 112 and may be non-centralized. Database 120 may be a database configured to store information used by authentication server 112 including, for example, historical consumer identity records and/or payment transaction records.

Database 120 may include a single database having separated sections or partitions, or may include multiple databases, each being separate from each other. Database 120 may store transaction data generated over the processing network including data relating to merchants, consumers, account holders, prospective customers, issuers, acquirers, and/or purchases made. Database 120 may also store account data including at least one of a cardholder name, a physical address associated with the cardholder, such as, a billing address and/or shipping address, a cardholder email address, a cardholder phone number, an account number, an IP address, other account identifiers, and/or transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authentication and authorization request data. For example, in some embodiments, database 120 may comprise data elements from over 2 billion identities and over 5 billion digital interactions. Database 120 may store one or more authorization profiles, where each authorization profile includes one or more identity insights rules, one or more severity level thresholds, and one or more routing rules based on the severity level thresholds. In some embodiments, one of the databases may be an authoritative data source (e.g., a databased that contains identity information about an individual and is considered to be the primary or most reliable source for this information).

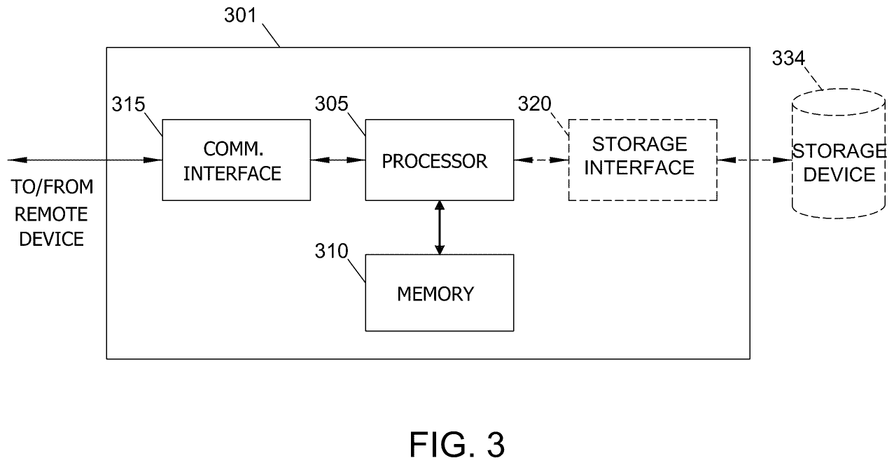

FIG. 3 illustrates an example configuration of a server system 301 such as authentication platform 34 (shown in FIG. 1), in accordance with one example embodiment of the present disclosure. Server system 301 may also include, but is not limited to, merchant website 104, data gathering computer device 106, ACS 108, issuer computing device 110, authentication server 112, and database server 116 (all shown in FIG. 2). In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from a client system (not shown) via the Internet, as illustrated in FIG. 2.

Processor 305 may also be operatively coupled to a storage device 334. Storage device 334 is any computer-operated hardware suitable for storing and/or retrieving data. In some embodiments, storage device 334 is integrated in server system 301. For example, server system 301 may include one or more hard disk drives as storage device 334. In other embodiments, storage device 334 is external to server system 301 and may be accessed by a plurality of server systems 301. For example, storage device 334 may include multiple storage units such as hard disks or solid state disks in a redundant array of inexpensive disks (RAID) configuration. Storage device 334 may include a storage area network (SAN) and/or a network attached storage (NAS) system.

In some embodiments, processor 305 is operatively coupled to storage device 334 via a storage interface 320. Storage interface 320 is any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are examples only, and are thus not limiting as to the types of memory usable for storage of a computer program.

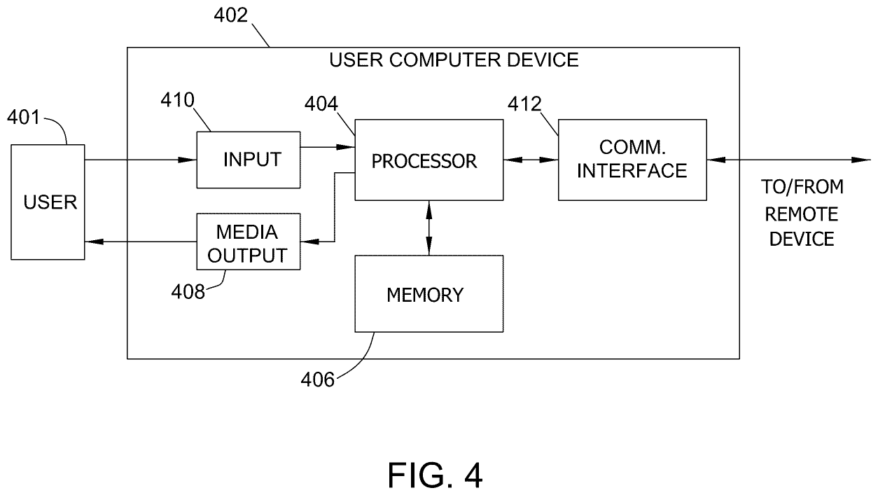

FIG. 4 illustrates an example configuration of a client computing device 402. Client computing device 402 may include, but is not limited to, cardholder computing device 102 (shown in FIG. 1). Client computing device 402 includes a processor 404 for executing instructions. In some embodiments, executable instructions are stored in a memory area 406. Processor 404 may include one or more processing units (e.g., in a multi-core configuration). Memory area 406 is any device allowing information such as executable instructions and/or other data to be stored and retrieved. Memory area 406 may include one or more computer-readable media.

Client computing device 402 also includes at least one media output component 408 for presenting information to a user 400. Media output component 408 is any component capable of conveying information to user 400. In some embodiments, media output component 408 includes an output adapter such as a video adapter and/or an audio adapter. An output adapter is operatively coupled to processor 404 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 402 includes an input device 410 for receiving input from user 400. Input device 410 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 408 and input device 410.

Client computing device 402 may also include a communication interface 412, which is communicatively couplable to a remote device such as server system 301 or a web server operated by a merchant. Communication interface 412 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

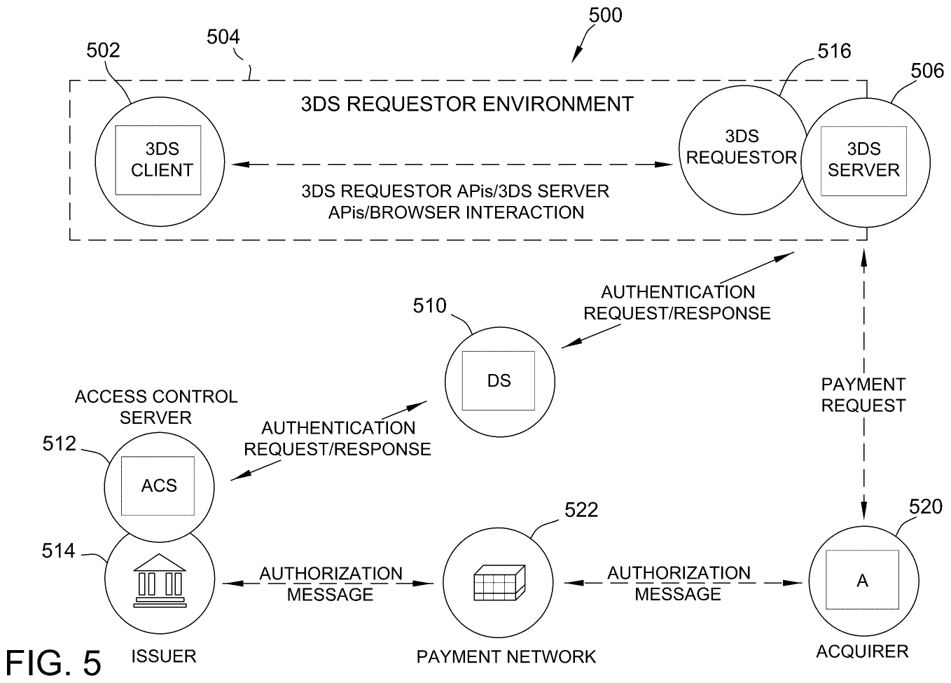

FIG. 5 is a schematic diagram illustrating transaction flow in an example authentication system 500 that uses the 3DS2 Protocol (or subsequent versions of the 3DS Protocol) for authentication. Information regarding the 3DS Protocol, including the current version of the protocol, can be found at https://www.emvco.com. System 500 includes a directory server 510 that facilitates authenticating a cardholder for a transaction, as described herein. Directory server 510 may be operated, for example, by interchange network 28 (shown in FIG. 1).

A cardholder (e.g., cardholder 22, shown in FIG. 1) initiates a transaction (e.g., an online transaction) on a cardholder computing device 102 (shown in FIG. 2), such as, for example, a mobile computing device. During initiation of the transaction, the cardholder provides authentication data that will ultimately be used to authenticate the cardholder. In the exemplary embodiment, this authentication data includes form data that the cardholder fills in to make the purchase and scraped data, which is data about the cardholder, such as device details and browser details including device ID, IP address, device channel, etc.

The authentication data is transmitted from the cardholder computing device 102 to a 3DS client 502 within a 3DS requestor environment 504. The 3DS client 502 may be operated by a merchant (e.g., merchant 24, shown in FIG. 1). In some embodiments, 3DS client 502 is a part of merchant website 104 (shown in FIG. 2) or a mobile app. 3DS client 502 collects, from the cardholder computing device 102, information necessary to authenticate the cardholder using the 3DS2 Protocol, including the authentication data.

The 3DS client 502 collects information (including the authentication data) and transmits the collected information to a 3DS server 506 for inclusion in an authentication request message, also referred to herein as an AReq message. 3DS client 502 is also part of the 3DS requestor environment 504. 3DS client 502 and 3DS server 506 may communicate with one another, for example, using application programming interfaces (APIs) or browser interactions. In some embodiments, the 3DS server 506 is similar to data gathering computer device 106 (shown in FIG. 2).

Using the authentication data provided by the cardholder and other data collected within 3DS requestor environment 504, the 3DS server 506 generates the AReq message and transmits the AReq message to directory server 510, based on the payment processor associated with the transaction card being used in the transaction. In some embodiments, the directory server 510 is similar to the authentication server 112 (shown in FIG. 2). That is, different payment processors will generally have different directory servers for processing transactions. When generating the AReq message, 3DS server 506 formats the data for security purposes. In this embodiment, directory server 510 forwards the AReq message to an appropriate access control server (ACS) 512, based on the issuer of the payment card. In some embodiments, ACS 512 is similar to ACS 108 (shown in FIG. 2).

ACS 512 determines, based on the AReq message, whether authentication is required. Further, ACS 512 facilitates ensuring that any required authentication is properly carried out. ACS 512 performs these authentication operations on behalf of an issuer operating an issuer computing device 514.

In response to the AReq message, ACS 512 returns an authentication response (ARes) message to directory server 510, which directory server 510 in turn forwards to 3DS server 506. Before returning the ARes message, ACS 512 evaluates the data in the AReq message and performs whether authentication is required on the transaction. Specifically, when ACS 512 determines that an explicit cardholder step-up authentication is not required (i.e., when the transaction is determined to be low risk), ACS 512 determines authentication is complete and returns an ARes indicating the same. If, however, ACS 512 determines that cardholder step-up authentication is required, ACS 512 initiates a step-up challenge request. The results of the step-up challenge requests are transmitted (in the ARes message), to 3DS server 506 (via directory server 510), and ultimately to the cardholder. If step-up authentication is required, ACS 512 controls the step-up authentication in accordance with methods used for cardholders of the issuer (e.g., biometric authentication, one time password (OTP) authentication, short message service (SMS) authentication, etc.). A 3DS requestor 516 included in 3DS requestor environment 504 controls how the various components interact with one another in the example embodiment.

After the authentication process is complete (i.e., after the 3DS Protocol is finished), if the cardholder is successfully authenticated, payment authorization for the transaction is undertaken. That is, the authentication using the 3DS2 Protocol (or subsequent versions of the 3DS Protocol) occurs before payment authorization for the transaction.

For payment authorization, the merchant (e.g., using 3DS server 506) exchanges authorization data with an acquirer computing device 520 operated by an acquirer, such as merchant bank 26 (shown in FIG. 1) and a payment network 522, such as interchange network 28 (shown in FIG. 1). If appropriate, the merchant, acquirer, or payment network may submit an authorization request including information that indicates authentication occurred. Acquirer computing device 520 then processes the authorization with issuer computing device 514 and returns the authorization results to the merchant.

The 3DS2 Protocol (and subsequent versions of the 3DS Protocol) provides a number of benefits to cardholders, issuers, and merchants. It reduces risk of unauthorized transactions through an approach that incorporates a rich, comprehensive set of data to make authentication decisions. For cardholders, it provides a simple, secure, and familiar online authentication experience, regardless of payment channel or device. For issuers, it allows for “frictionless” authentication, in which an explicit cardholder step-up authentication is not required or performed. This enables more intelligent risk assessment decisions and the ability to selectively challenge the cardholder as needed. This also improves cardholder experience and overall cardholder loyalty to issuers. For merchants, the 3DS2 Protocol decreases fraud on all authenticated transactions, and increases revenue potential from reduced friction and reduced cart abandonment (i.e., cardholders deciding not to complete a transaction after they have already selected one or more items to be purchased), especially for mobile payment channels. This also improves cardholder experience and overall cardholder loyalty to merchants.

Using 3DS2 Protocol (or subsequent versions of the 3DS Protocol), payment networks see 100% of all authentication requests globally on all cards on their brands. No other party, including issuers and ACS providers, is able to provide this global visibility. This global visibility may be leveraged to provide a consistent, standards-based risk analysis of transactions on behalf of issuers, enabling a market wide risk-based authentication approach.

As compared to previous authentication methods (e.g., 3DS 1.0), the 3DS2 Protocol (and subsequent versions of the 3DS Protocol) allows for approximately ten times the amount of transaction data to be gathered, analyzed, and utilized to prevent fraud. The additional data included in the 3DS Protocol increases data exchange between merchants and issuers, and improves authentication decisioning. The authentication decisioning allows issuers to examine every authentication request through transaction risk analysis, while focusing fraud prevention efforts on transactions that prevent the most risk. Further, the authentication decisioning utilizes both behavioral and transactional inputs in conjunction with a risk engine to determine riskiness of a transaction.

Transactions deemed safe or low risk are silently authenticated (i.e., so-called “frictionless” authentication), while higher risk transactions are subjected to step-up authentication. When a low-risk transaction is silently authenticated, so much data has already been gathered that further authentication adds little to no value. Accordingly, authentication reasoning effectively replaces the need for an explicit interaction with the cardholder for every transaction, but transactions are still fully authenticated, with liability resting with the issuer. Thus, more transactions are completed with minimal cardholder disruption, aiding e-commerce growth.

One goal of authentication reasoning is to minimize the number of transactions that require active (i.e., step-up) authentication, while keeping fraud to a minimum and improving consumer friction points during the transaction process. With authentication reasoning, the information gathered enables transaction scoring and classification into low, medium, and high risk, allowing the issuer and ACS 512 to take appropriate action. However, at least some issuers and/or ACSs do not have the capability to perform more sophisticated (and thus more accurate) authentication procedures. In addition, issuers and/or ACSs that are able to provide some level of fraud detection capability may temporarily lose such capability (e.g., due to equipment malfunction), directly impacting their ability to successfully authenticate online users.

The 3DS2 Protocol (and subsequent versions of the 3DS Protocol) enables a marketwide level risk analysis of all transactions that reach directory server 510. Each transaction can be scored and/or flagged based on the global data available using the 3DS2 Protocol (and subsequent versions of the 3DS Protocol). Additionally, the payment processor operating the directory server 510 has the ability to see cardholder activity across the digital and physical domains, and can utilize this expanded view to improve scoring. In contrast, traditional authentication service providers may only address the digital domain. For example, a payment processor could indicate if a particular device is associated with fraud, and flag that device for issuers in future transactions. The issuer may then reject transactions involving that device or prompt for additional authentication (e.g., through two-factor authentication).

The following Table 2 lists a number of the data elements that are used in the 3DS2 Protocol for authentication. For example, at least some of these data elements may be included in the authentication data included in the AReq sent to directory server 510. The eighteen data elements that are also part of the 3DS 1.0 Protocol are bolded in Table 2. Those of skill in the art will appreciate that the number of rich data elements could grow beyond those listed below (e.g., in future versions of the 3DS Protocol), and could include over one hundred and seventy data elements. Further, an app-based transaction (e.g., carried out using a mobile computing device) could provide even more data elements than browser-based transactions. In addition, a transaction performed using an Android device could have over one hundred and thirty additional elements.

TABLE 2

| | Data Element |
|---|---|
| 1 | 3DS Requestor Authentication Information |
| 2 | 3DS Requestor Challenge Indicator |
| 3 | 3DS Requestor ID |
| 4 | 3DS Requestor Initiated Indicator |
| 5 | 3DS Requestor Name |
| 6 | 3DS Requestor Non-Payment Authentication Indicator |
| 7 | 3DS Requestor Prior Transaction Authentication |
| | Information |
| 8 | 3DS Requestor URL |
| 9 | 3DS Server Operator ID |
| 10 | 3DS Server Reference Number |
| 11 | 3DS Server Transaction ID |
| 12 | 3DS Server URL |
| 13 | Account Type |
| 14 | Acquirer BIN |
| 15 | Acquirer Merchant ID |
| 16 | ACS Challenge Mandated Indicator |
| 17 | ACS Counter ACS to SDK |
| 18 | ACS HTML |
| 19 | ACS Operator ID |
| 20 | ACS Reference Number |
| 21 | ACS Rendering Type |
| 22 | ACS Signed Content |
| 23 | ACS Transaction ID |
| 24 | ACS UI Type |
| 25 | Address Match Indicator |
| 26 | Authentication Method |
| 27 | Authentication Type |
| 28 | Authentication Value |
| 29 | Browser Accept Headers |
| 30 | Browser IP Address |
| 31 | Browser Java Enabled |
| 32 | Browser Language |
| 33 | Browser Screen Color Depth |
| 34 | Browser Screen Height |
| 35 | Browser Screen Width |
| 36 | Browser Time Zone |
| 37 | Browser User-Agent |
| 38 | Card/Token Expiry Date |
| 39 | Cardholder Account Identifier |
| 40 | Cardholder Account Information |
| 41 | Cardholder Account Number |
| 42 | Cardholder Billing Address City |
| 43 | Cardholder Billing Address Country |
| 44 | Cardholder Billing Address Line 1 |
| 45 | Cardholder Billing Address Line 2 |
| 46 | Cardholder Billing Address Line 3 |
| 47 | Cardholder Billing Address Postal Code |
| 48 | Cardholder Billing Address State |
| 49 | Cardholder Email Address |
| 50 | Cardholder Home Phone Number |
| 51 | Cardholder Mobile Phone Number |
| 52 | Cardholder Name |
| 53 | Cardholder Shipping Address City |
| 54 | Cardholder Shipping Address Country |
| 55 | Cardholder Shipping Address Line 1 |
| 56 | Cardholder Shipping Address Line 2 |
| 57 | Cardholder Shipping Address Line 3 |
| 58 | Cardholder Shipping Address Postal Code |
| 59 | Cardholder Shipping Address State |
| 60 | Cardholder Work Phone Number |
| 61 | Challenge Additional Information Text |
| 62 | Challenge Cancelation Indicator |
| 63 | Challenge Data Entry |
| 64 | Challenge HTML Data Entry |
| 65 | Challenge Information Header |
| 66 | Challenge Information Label |
| 67 | Challenge Information Text |
| 68 | Challenge Information Text Indicator |
| 69 | Challenge Selection Information |
| 70 | Challenge Window Size |
| 71 | Device Channel |
| 72 | Device Information |
| 73 | Device Rendering Options Supported |
| 74 | DS Reference Number |
| 75 | DS Transaction ID |
| 76 | DS URL |
| 77 | Electronic Commerce Indicator |
| 78 | EMV Payment Token Indicator |
| 79 | Expandable Information Label 1 |
| 80 | Expandable Information Text 1 |
| 81 | Instalment Payment Data |
| 82 | Interaction Counter |
| 83 | Issuer Image |
| 84 | Merchant Category Code |
| 85 | Merchant Country Code |
| 86 | Merchant Name |
| 87 | Merchant Risk Indicator |
| 88 | Message Category |
| 89 | Message Extension |
| 90 | Message Type |
| 91 | Message Version Number |
| 92 | Notification URL |
| 93 | OOB App Label |
| 94 | OOB App URL |
| 95 | OOB Continuation Indicator |
| 96 | OOB Continuation Label |
| 97 | Payment System Image |
| 98 | Purchase Amount |
| 99 | Purchase Currency |
| 100 | Purchase Currency Exponent |
| 101 | Purchase Date & Time |
| 102 | Recurring Expiry |
| 103 | Recurring Frequency |
| 104 | Resend Challenge Information Code |
| 105 | Resend Information Label |
| 106 | Results Message Status |
| 107 | SDK App ID |
| 108 | SDK Counter SDK to ACS |
| 109 | SDK Encrypted Data |
| 110 | SDK Ephemeral Public Key (Qc) |
| 111 | SDK Reference Number |
| 112 | SDK Transaction ID |
| 113 | Submit Authentication Label |
| 114 | Transaction Status |
| 115 | Transaction Status Reason |
| 116 | Transaction Type |
| 117 | Why Information Label |
| 118 | Why Information Text |

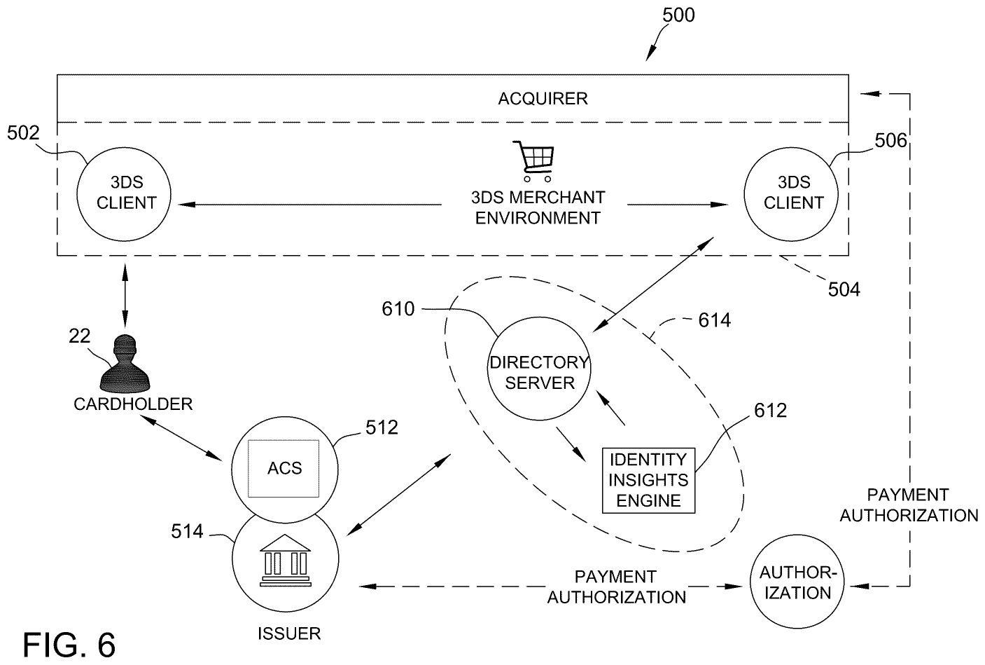

FIG. 6 is a schematic diagram illustrating transaction flow in another example authentication system 600 that uses the 3DS2 Protocol (or subsequent versions of the 3DS Protocol) for authentication, and that performs identity insight checks. Unless otherwise indicated, components of authentication system 600 are substantially similar to those of authentication system 500 (shown in FIG. 5).

Instead of directory server 510, authentication system 600 includes an identity insights enabled directory server 610 communicatively coupled to an identity insights engine 612 (which may be collectively referred to as authentication platform 614). Identity insights engine 612 may communicate with other components of authentication system 600, for example, using application programming interfaces (APIs) or browser interactions. Identity insights enabled directory server 610 and identity insights engine 612 facilitate performing an identity checks, as described herein. Identity insights enabled directory server 610 and identity insights engine 612 may be operated, for example, by interchange network 28 (shown in FIG. 1). In some embodiments, authentication platform 614 is similar to authentication platform 34 (shown in FIG. 1) and authentication server 112 (shown in FIG. 2).

As in authentication system 500, identity insights enabled directory server 610 receives an AReq message from 3DS server 506. The authentication request message includes authentication data that includes digital transaction data and consumer identity data that may be provided to the directory server by the merchant or on behalf of the merchant. The consumer identity data may be captured by the merchant when the consumer or purchaser enters their information into a webpage of the merchant to make a purchase. For example, the consumer identity data may include a first and last name of the consumer or purchaser, an email address, a phone number, a mailing address, and an IP (Internet Protocol) address for the device used to access the merchant website and initiate the purchase. This data may be collected as part of an e-commerce transaction via EMV 3-D Secure. The merchant environment collects this rich EMV 3-D Secure data, and then transmits it to the payment processor for identity insights processing. Identity insights enabled directory server directory server 610 transmits at least some of the data in the AReq message (e.g., the authentication data) to identity insights engine 612.

The authorization message is in an ISO 8583 or ISO 20022 message formats for processing over a dedicated payment processing network. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

In some embodiments, identity insights engine 612 extracts and analyzes the consumer identity data from the AReq message to generate identity insight result data. In some embodiments, the consumer identity data comprises cardholder name (first, middle, and/or last name), email, phone number, IP address, and one or more physical addresses (e.g., shipping address and/or billing address).

In some embodiments, identity insights engine 612 may compare the consumer identity data extracted from the AReq message to stored cardholder profile data. The stored cardholder profile data may comprise one or more of a cardholder name (first, middle, and/or last name), email, phone number, IP address, and one or more physical addresses (e.g., shipping address and/or billing address). The cardholder profile may be stored in one or more databases accessible by identity insights engine 612 and operated by interchange network 28. Since the payment processor processes so many transactions for a cardholder, the identity insight engine is able to build a robust cardholder profile for making the identity determination. For example, the one or more databases may comprise data elements from over 2 billion identities and over 5 billion digital interactions. In some embodiments, one of the databases may be an authoritative data source (e.g., a databased that contains identity information about an individual and is considered to be the primary or most reliable source for this information). In some embodiments, the consumer profile data is hashed prior to storing to protect the security of this personally identifiable information.

In some embodiments, the identity insights result data generated by identity insights engine 612 includes an identity score, a fraud likelihood level, and at least one reason code. The identity score is a score representing a determined likelihood that a consumer identity associated with the transaction is fraudulent, with lower scores indicating a likelihood that the consumer identity is genuine and higher scores indicating a likelihood that the consumer identity is fraudulent. In other words, the identity score represents a likelihood that the suspect cardholder (e.g., the person attempting to perform a transaction) is the legitimate cardholder having the privileges to use the payment card to perform a payment transaction. For example, the identity score may be represented by a number from 0-999, or 0-500, and/or by a severity threshold category from 0-19. In some embodiments, identity in assessments that will be shared, such as through the authorization field of one or more messages will be quantified on a scale of 0-9. Those of skill in the art will appreciate that any suitable identity score may be used. In some embodiments, the identity score and reasons codes may be provided to the ACS as a further data signal (in addition to the transaction data) used for determining whether to send a step-up challenge to further authenticate the online purchaser.

The identity insights analysis is a description of a level of severity corresponding to the identity score (e.g., low severity, medium severity, or high severity). Further the reason codes include one or more factors that influenced the identity score. Identity insights engine 612 transmits the identity insights result data to identity insights enabled directory server 610.

In some embodiments, the reason codes explain the basis for the generated score. More particularly, identity insights engine 612 may activate one or more anchors based on the analysis of the data in the AReq message. For example, in some embodiments, identity insights engine 612 may activate one or more anchors based on how the model determined the identity score. The reason codes may then be generated based on which anchors (and how many anchors) are activated. In some embodiments, one or more of the following identity elements from a consumer transaction may act as anchors: name, email address, phone number, IP address, and one of more physical addresses (e.g., billing address, shipping address, etc.). Those of skill in the art will appreciate that additional and/or alternative anchors may be established.

Based on analysis of the consumer data extracted from the AReq message, identity insights engine 612 may activate at least one anchor. For example, if identity insights engine 612 determines that a shipping address for the transaction is the same as the IP address location, identity insights engine 612 may activate the shipping address and the IP address anchors.

The following are some additional examples of criteria for activating anchors for the different categories. In one example, the shipping address anchor is activated if the shipping address has been used with the PAN in past transactions, the shipping address is the same as the billing address on file, the shipping address is not on a list of “bad” shipping addresses, and the shipping address is unchanged from a prior transaction. In a second example, the shipping address anchor, the billing address anchor, and the PAN anchor are activated when the shipping address is consistent with previous transactions, the billing address is consistent with previous transactions, the PAN has historical positive association with the cardholder, and the purchase amount, date, and time are consistent with previous transactions. Those of skill in the art will appreciate that the anchors may be activated based on any suitable conditions.

The reason codes are generated based on the activated anchors, and are loosely structured in a hierarchical order based on connections between anchors in different categories. For example, if at least one anchor in the cardholder category is activated, a positive reason code (i.e., indicating relatively low severity) is generated. If, instead, at least one anchor in the cardholder category is activated and at least one anchor in the merchant category is also activated, a stronger positive reason code related to both categories is generated. Similarly, if at least one anchor in the cardholder category is activated, at least one anchor in the merchant category is activated, and at least one anchor in the environment category is activated, an even stronger positive reason code related to all three categories is generated.

The following Table 3 lists of number of example reason codes. However, those of skill in the art will appreciate that additional and/or alternative reason codes may be utilized in accordance with the embodiments described herein.

TABLE 3

| | Severity | |
|---|---|---|
| Code | Level | Description |
| AA | High | Consumer Identity is suspicious |
| AB | High | Increased Risk associated with Email |
| AC | High | Increased Risk associated with Email & IP |
| AD | High | Increased Risk associated with Email & Address |
| AE | High | Increased Risk associated with Email & Phone |
| AF | High | Increased Risk associated with Email & Name |
| AG | High | Increased Risk associated with IP |
| AH | High | Increased Risk associated with IP & Phone |
| AI | High | Increased Risk associated with IP & Address |
| AJ | High | Increased Risk associated with IP & Name |
| AK | High | Increased Risk associated with Address |
| AL | High | Increased Risk associated with Address & Phone |
| AM | High | Increased Risk associated with Address & Name |
| AN | High | Increased Risk associated with Name |
| AO | High | Increased Risk associated with Name & Phone |
| AP | High | Increased Risk associated with Phone |
| JA | Medium | New Consumer or not sufficient information |
| JB | Medium | Medium Risk Signals associated with Email |
| JC | Medium | Medium Risk Signals associated with Address |
| JD | Medium | Medium Risk Signals associated with Phone |
| JE | Medium | Medium Risk Signals associated with Name |
| JF | Medium | Medium Risk Signals associated with IP |
| RA | Low | Consumer Trust Established across all PII elements |
| RB | Low | Established Credibility for Email |
| RC | Low | Established Credibility for Email & IP |
| RD | Low | Established Credibility for Email & Address |
| RE | Low | Established Credibility for Email & Phone |
| RF | Low | Established Credibility for Email & Name |
| RG | Low | Established Credibility for IP |
| RH | Low | Established Credibility for IP & Phone |
| RI | Low | Established Credibility for IP & Address |
| RJ | Low | Established Credibility for IP & Name |
| RK | Low | Established Credibility for Address |
| RL | Low | Established Credibility for Address & Phone |
| RM | Low | Established Credibility for Address & Name |
| RN | Low | Established Credibility for Name |
| RO | Low | Established Credibility for Name & Phone |
| RP | Low | Established Credibility for Phone |
| RP | Low | Established Credibility for Phone |

After identity insights engine 612 generates the identity insights result data (including the reason codes), identity insights enabled directory server 610 injects the identity insights result data into the authorization request message to generate an enhanced authorization request message. For example, in some embodiments, the identity insights result data is appended to the authorization message as an extensible markup language (XML) extension of the authorization message. For example, the extension may have the following format:

```
“name”: “DII”,
“id”: “A000000004-DII”,
“criticalityIndicator”: “true”,
“data”: {
  “status”:“success”,
  “score”:“1”,
  “decision”:“low severity”,
    “reasonCode1”:“R”,
  “reasonCode2”:“D”}
```

where “score” is the identity score, “decision” is the fraud likelihood level, and “reasonCode1” and “reasonCode2” are the reason codes. In the exemplary embodiment, the reason codes are transmitted as a single letter each. The combination of the two reason codes may provide one holistic insight. For example, in some embodiments, the combination of two reason codes may indicate a “high” severity, a “medium” severity, or a “low” severity of identity fraud. In other embodiments, the reason codes may be represented in different methods. In some embodiments, the identity insights result data may be injected into an authorization request message (e.g., an ISO 8583 or ISO 20022 compliant message in Date Element 48 and Sub Element 56) to generate an enhanced authorization request message.

The enhanced authorization request message is transmitted to the issuer to enable the issuer to make an authentication decision based on the identity insights result data. That is, in the example embodiment, issuer 514 may determine to fully authenticate the transaction, deny authentication for the transaction, or perform additional authentication (e.g., by issuing a step-up challenge to the cardholder) for the transaction, based on at least one of the identity score, the fraud likelihood level, and the reason codes. Accordingly, issuer 514 and/or ACS 512 does not perform the identity insights analysis, but is still able to leverage the results of that analysis to make an authentication decision (e.g., by using the results in their own fraud analysis platform), generally resulting in more approvals with less fraud and without necessarily providing the actual secure data to certain parties that typically do not have access to such data.

In some embodiments, where the identity score strongly indicates that the identity is genuine, instead of generating and transmitting an enhanced AReq message to ACS 512, identity insights enabled directory server 610 fully authenticates the transaction itself. Specifically, where the identity score strongly indicates that the identity is genuine, identity insights enabled directory server 610 automatically generates an ARes that indicates the transaction has been fully authenticated, and transmits the ARes message to 3DS server 506. Identity insights enabled directory server 610 determines that the severity of the transaction is low by comparing at least one of the identity score and the fraud likelihood level to a predetermined threshold. The predetermined threshold may be specified, for example, by issuer 514. Accordingly, issuer 514 is able to control which transactions will be fully authenticated without issuer 514 performing any of the analysis.

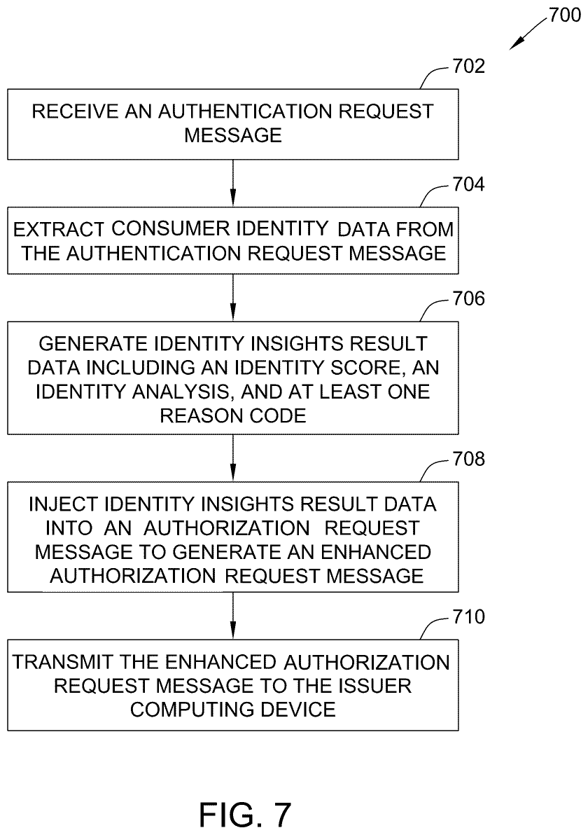

FIG. 7 is a flow diagram of an example method 700 for providing an enhanced authorization message to an issuer. Method 700 may be implemented, for example, using authentication platform 614 (shown in FIG. 6). Method 700 includes receiving 702 an authentication request message, the authentication request message includes authentication data. Method 700 further includes extracting 704 the authentication data from the authentication request message. Method 700 further includes 706 generating, based at least in part on the extracted authentication data, identity insights result data including an identity score, a fraud likelihood level, and at least one reason code. In addition, method 700 includes injecting 708 the identity insights result data into the authorization request message to generate an enhanced authorization request message. Further, method 700 includes transmitting 710 the enhanced authorization request message to the issuer to enable the issuer to make an authentication decision based on the identity insights result data.

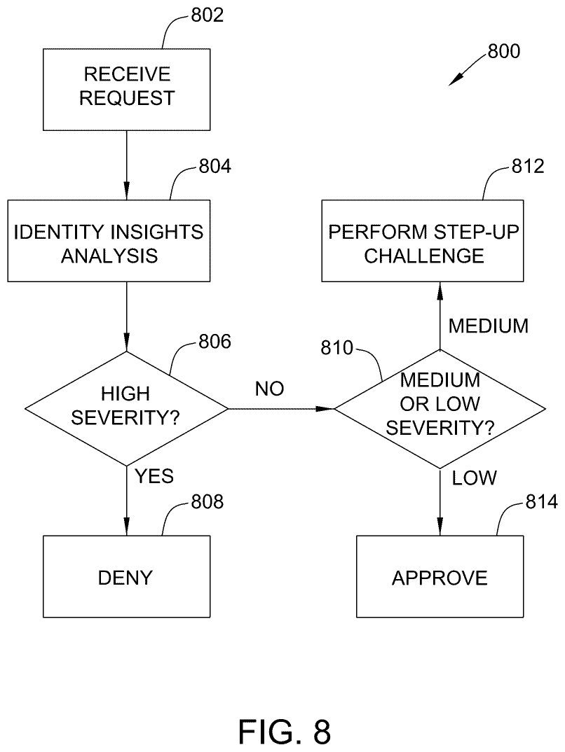

FIG. 8 is a flow diagram of another example method 800 for authenticating an online user. Method 800 may be implemented, for example, using authentication platform 614 (shown in FIG. 6).

In the example embodiment, authentication platform 614 receives 802 an authentication request message including authentication data, as described herein. Identity insights platform 614 performs 804 an identity insights analysis to generate identity insights result data including an identity score, a fraud likelihood level, and at least one reason code. The identity score is a score representing a likeliness that the consumer identity is genuine, with lower scores indicating the consumer identity is likely authentic and higher scores indicating the consumer identity is likely fraudulent. In other words, the identity score represents a likelihood that the suspect cardholder (e.g., the person attempting to perform a transaction) is the legitimate cardholder having the privileges to use the payment card to perform a payment transaction. For example, the identity score may be represented by a number from 0-999, or 0-500, or some other value range. In some embodiments, identity insights assessments that will be shared, such as through the authorization field of one or more messages, will be quantified on a scale of 0-9. The reason codes include one or more factors that influenced the identity score.

In some embodiments, authentication platform 614 compares the identity insights result data to a stored authorization profile. The authorization profile contains a plurality of rules for the processing of authentication requests. In some embodiments, the authorization profile is provided by the issuer computing device 514 (shown in FIG. 5). Examples of the rules include, but are not limited to, information to include in the identity insights analysis, thresholds associated with the identity score, decision making identity thresholds, and specialized rules (such as all cross-border transactions are to be submitted to the ACS 512). The authorization profile is stored at the authentication platform, and can be accessed whenever an identity insights score is determined.

In some embodiments, authentication platform 614 compares the identity insights result data to the authorization profile to determine the authenticity of the consumer identity associated with the authentication request. In some embodiments, authentication platform 614 compares the identity score to one or more thresholds in the authorization profile to determine the authenticity of the consumer identity associated with the transaction. In other embodiments, authentication platform 614 compares the identity score, the fraud likelihood level, the reason codes, and/or any other combination of data from the identity insights result data and potentially some or all of the consumer identity data to the consumer identity profile to determine the authenticity of the consumer identity associated with this transaction. For example, an identity score of 3 or less may be considered low likelihood of fraud, an identity score between 4 and 7 may be considered medium likelihood of fraud, and an identity score above 8 may be considered high likelihood of fraud. Those skilled in the art will appreciate that any suitable identity score thresholds and any number of fraud likelihood levels may be used.

In some embodiments, authentication platform 614 determines 806 if the consumer identity has a high likelihood of fraud, a medium likelihood of fraud, or a low likelihood of fraud. For example, authentication platform 614 may determine 806 that the consumer identity is clearly fraudulent. In such a case, authentication platform 614 may deny the 808 the transaction. Identity insights platform 614 transmits an authentication response (ARes) message including the denial to 3DS server 506 (shown in FIG. 5). 3DS server 506 may transmit the ARes message including the denial to the merchant, where the merchant determines whether or not to proceed with the authorization process. In these embodiments, where the merchant begins the authorization process after having received a denial, the transaction is considered to be merchant only authentication, where the merchant assumes the risk for the transaction.

When authentication platform 614 determines the transaction is clearly fraudulent, authentication platform 614 denies the transaction without sending on authentication data (e.g., to the issuer and/or ACS). Specifically, authentication platform 614 fails the authentication and communicates the failure to the authentication requestor in the ARes message. Based on this failure, the merchant should not then submit the transaction for authorization, thus terminating the transaction. Accordingly, because the transaction is denied during authentication (and prior to authorization), no authorization messages are sent over the payment processing network. This protects the security of the payment processing network because the payment processing network is never exposed to authorization data associated with the fraudulent transaction. Further, authentication platform 614 may notify the issuer and/or merchant that the transaction was clearly fraudulent, enabling the issuer and/or merchant to take appropriate action (e.g., flagging the associated account number and/or cardholder).

Identity insights platform 614 determines 810 if the transaction is medium likelihood of fraud or low likelihood of fraud. If the transaction is low likelihood of fraud, authentication platform 614 may approve 814 the transaction and transmit an authentication response (ARes) message including the approval to 3DS server 506, where at least one of the 3DS server 506 and the merchant may initiate the authorization process. If the transaction is medium likelihood of fraud, authentication platform 614 may issue 812 a step-up challenge to the cardholder 22 (shown in FIG. 1). Based on the results of the step-up challenge, authentication platform 614 may approve or deny the transaction. In some embodiments, if the transaction is medium likelihood of fraud, authentication platform 614 transmits the identity insights result data to issuer 514 and/or ACS 512 so that step-up challenge may be performed. In other embodiments, authentication platform 614 may take different steps at different fraud likelihood levels and have additional or fewer likelihood levels to analyze based on the authorization profile.

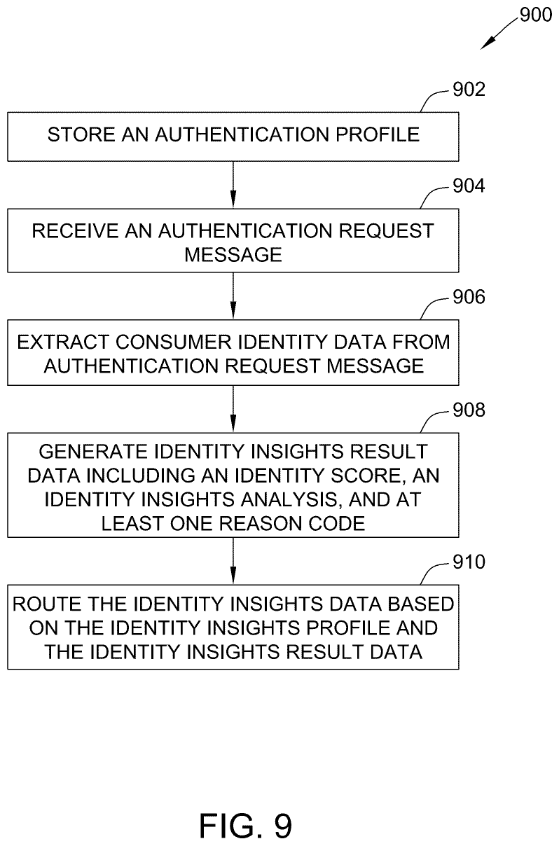

FIG. 9 is a flow diagram of another example method 900 for authenticating an online user. Method 900 may be implemented, for example, using authentication platform 614 (shown in FIG. 6). Method 900 includes storing 902 an authorization profile. The authorization profile contains a plurality of rules for the processing of authentication requests. The method 900 also includes receiving 904 an authentication request message, the authentication request message includes consumer identity data. Method 900 further includes extracting 906 the consumer identity data from the authentication request message. Method 900 further includes generating 908, based at least in part on the extracted consumer identity data, identity insight result data including an identity score, a fraud likelihood level, and at least one reason code. In addition, method 900 includes routing 910 the identity insights result data based on the authorization profile and the identity insights result data.

In some embodiments, authentication platform 614 transmits the identity insights result data to a source of the authentication request message, such as the 3DS server 506 (shown in FIG. 5). For example, in some embodiments, a merchant operating the 3DS server 506 may request and receive the identity insights result data, including an identity score, a fraud likelihood level, and at least one reason code as described herein. The merchant may use the identity insights result data to update the merchant's own fraud models, and may also compare the identity insights result data to fraud analysis results generated independently by the merchant to determine whether the identity insights result data is generally consistent with the merchant-generated fraud analysis results.

In some embodiments, the authentication request message is associated with an online payment card transaction. The authorization profile is associated with an issuer bank 30 (shown in FIG. 1) and the source of the authentication request message is the issuer computing device 514 (shown in FIG. 5). Accordingly, in some embodiments, the authentication platform 614 transmits the identity insights result data directly to the issuer computing device 514, and handles authentication with the issuer computing device 514. For example, the issuer bank 30 may enroll a range of card numbers with the authentication platform 614, and request that the authentication platform 614 work directly with the issuer computing device 514 for authentication of transactions involving card numbers in the enrolled range.

In some embodiments, authentication platform 614 determines a fraud likelihood level based on the identity insights result data and the authorization profile. In some of these embodiments, the fraud likelihood level includes at least low fraud likelihood, medium fraud likelihood, and high fraud likelihood for the consumer identity if the transaction associated with the authentication request. In these embodiments, authentication platform 614 transmits an authentication approval message to the 3DS server 506, if the fraud likelihood level is low.

If the fraud likelihood level is medium, authentication platform 614 transmits a step-up challenge to the online user 22 (shown in FIG. 1). Identity insights platform 614 receives a response to the step-up challenge from the online user 22. Identity insights on platform 614 determines an authentication decision based on the response to the step-up challenge and the identity insights result data. In some other embodiments, if the fraud likelihood level is medium, the authentication platform 614 transmits the identity insights result data to the issuer 514 and/or ACS 512 if the fraud likelihood level is medium so that a step-up challenge may be performed with the online user 22.

If the fraud likelihood level is high, authentication platform 614 transmits an authentication denied message to the 3DS server 506.

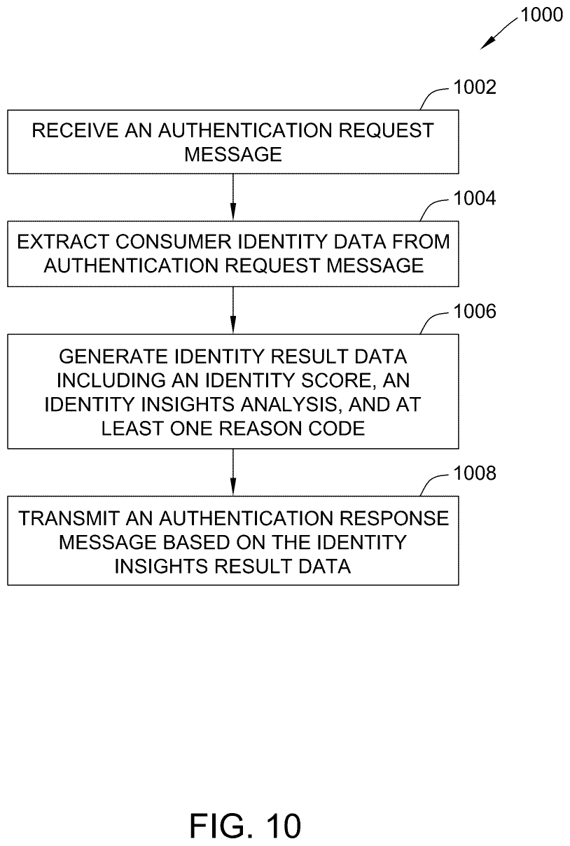

FIG. 10 is a flow diagram of a further example method 1000 for authenticating an online user. Method 1000 may be implemented, for example, using authentication platform 614 (shown in FIG. 6). Method 1000 includes receiving 1002 an authentication request message for a transaction. The authentication request message includes authentication data. Method 1000 also includes extracting 1004 consumer identity data from the authentication request message. The method 1000 further includes generating 1008, based at least in part on the extracted consumer identity data, identity insights result data including an identity score and at least one reason code that indicates at least one factor that influenced the generated identity score. Method 1000 further includes transmitting 1010 an authentication response message based on the identity insight result data. In some embodiments, authentication platform 614 generates an authentication decision based, at least in part, on the identity insights result data and injects the authentication decision in the authentication response message.

In some embodiments, authentication platform 614 performs the authentication process on the transaction, including identity insights analysis. In some embodiments, the identity insights analysis is based on a machine learning model where, over time, authentication platform 614 is capable of improving its ability to determine the identity score associated with transactions. In some embodiments, authentication platform 614 may be configured to retrieve historical data and compile the historical data to build a historical identity record. Authentication platform 614 may store the historical identity record within a database for later use. The historical identity data may comprise data elements (e.g., name, email address, phone number, IP address, billing address, shipping address, etc.) from over 2 billion identities and over 5 billion transactions.

Authentication platform 614 may retrieve a plurality of historical identity records from the database to build a training dataset. The training dataset may be used to train an identity insights model. The identity insights model may be generated and/or trained using the training database using any suitable analysis and/or statistic technique. In some embodiments, the identity insights model may include a plurality of model parameters for comparing individual parameters to determined parameters, as described herein. In other embodiments, the identity insights model may be in a different format, such as a function or a set of functions. In some embodiments, the identity insights model leverages one or more clustering algorithms.

Authentication platform 614 analyzes transactions that are authenticated by the ACS and the identity insights model compares these transactions with historical data to generate an identity insights model for each issuer. By comparing the data points in each transaction, the identity insights model will indicate the likelihood of identity fraud associated with each transaction based on the consumer identity data in the corresponding authentication requests. This allows authentication platform 614 to analyze consumer identities in transactions and perform authentication on these transactions to provide a response to the authentication request. Accordingly, authentication platform 614 may determine that a received authorization request is substantially similar to a previous transaction that the issuer approved. Thus, allowing authentication platform 614 to determine that the received transaction has a low likelihood of identity fraud.

Authentication platform 614 may update the training set by creating one or more new historical identity records. In particular, authentication platform 614 may generate new historic event records in response to outcomes, and authentication platform 614 may add the newly generated historical event records to the training dataset to generate an updated dataset. Subsequently, authentication platform 614 may re-train the identity insights model using the updated training dataset, further improving the accuracy of the identity insights model.

In some embodiments, authentication platform 614 determines a fraud likelihood level based on the identity insights result data. If the fraud likelihood level is low, authentication platform 614 injects an indicator in the authentication response message indicating that the transaction is “fully authenticated.” If the fraud likelihood level is not low, authentication platform 614 injects one or more indicators in the authentication response message indicating that the transaction is a merchant only transaction and that authentication was attempted. In some cases, authentication platform 614 generates the identity score and reason codes, and provides that to the ACS in an enhance authentication message along with the transaction data so that the ACS can further analyze the identity score along with the transaction data to better determine whether to perform a step-up challenge or to authenticate the transaction without further intervention.

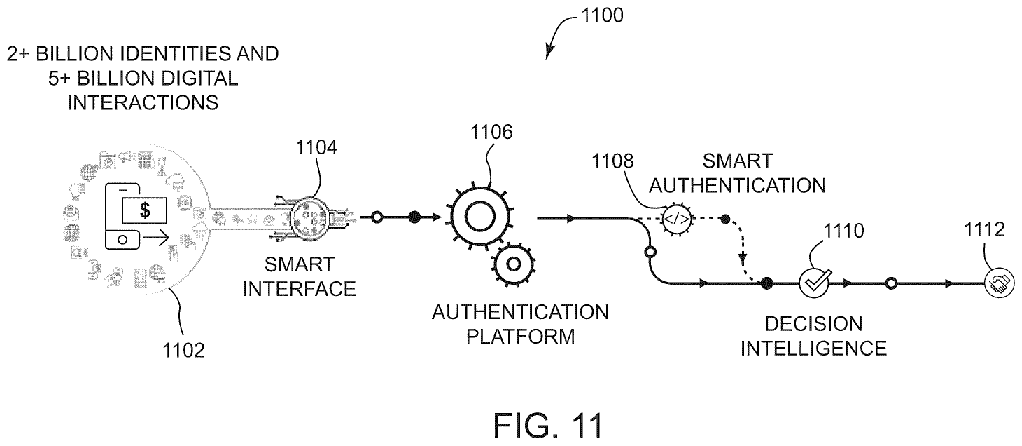

FIG. 11 is a flow diagram of an advanced authentication process 1100 for increasing approvals, reducing fraud, and improving consumer experience. Authentication process 1100 may be implemented, for example, using the systems and methods described herein. As shown in FIG. 11, consumer identity data 1102 is transmitted to an authentication platform 1106 (such as authentication platform 614) through a smart interface 1104. As described above, as compared to previous authentication methods (e.g., 3DS 1.0), consumer identity data 1102 under the 3DS2 Protocol (and subsequent versions of the 3DS Protocol) includes data from over two billion identities and over 5 billion digital interactions to be gathered, analyzed, and utilized to prevent identity fraud. Using consumer identity data 1102, authentication platform 1106 performs smart authentication 1108 (as described herein) to generate identity insights results data. Decision intelligence (DI) 1110 uses other sources of data (i.e., a separate model) to influence authorization decisions. In some embodiments, the identity results data may be incorporated into DI 1110. These assessments enable an interested party 1112 (e.g., the ACS, the merchant, and/or the issuer) to complete authentication (and authentication) of the transaction.

Authentication process 1100 enables authenticating an online user as a legitimate user of a payment account without having to ask additional questions of the user (e.g., as part of a step-up challenge) or having to request additional inputs from the user. Thus, authentication process 1100 assesses a fraud likelihood of fraud without creating any additional friction for the user that may cause the user to terminate a transaction.

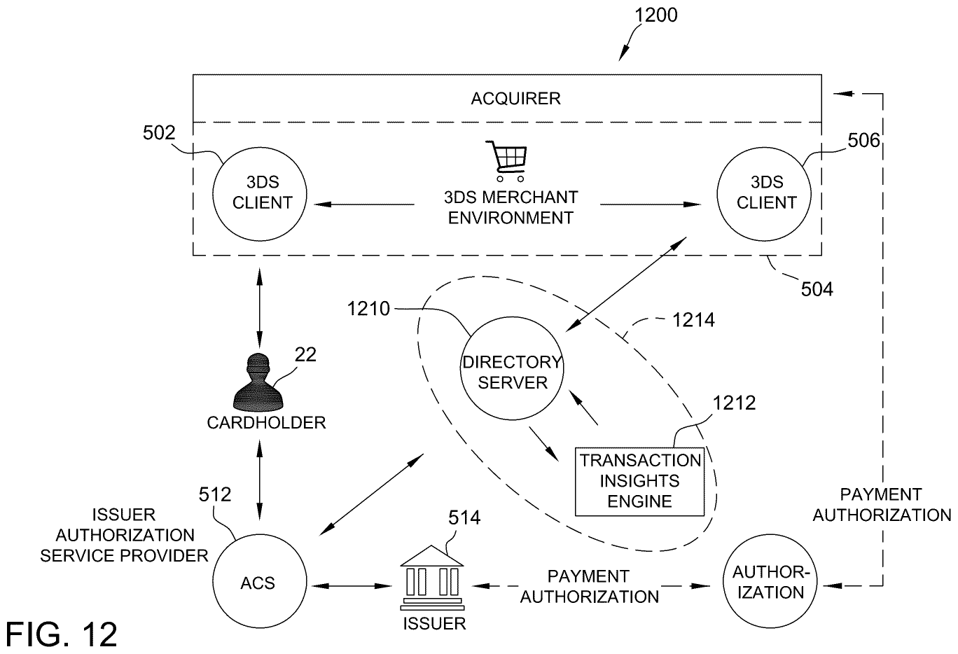

FIG. 12 is a schematic diagram illustrating transaction flow in another example authentication system 1200 that uses the 3DS2 Protocol (or subsequent versions of the 3DS Protocol) for authentication, and that performs a transaction insights analysis on behalf of ACS providers that are unable to perform a transaction insights analysis. In contrast to authentication system 600, which generates identity insights based on a rich, comprehensive set of identity data, authentication system 1200 generates transaction insights based on metadata associated with the online transaction. Unless otherwise indicated, components of authentication system 1200 are substantially similar to those of authentication system 500 (shown in FIG. 5).

Instead of directory server 510, authentication system 1200 includes a transaction insights enabled directory server 1210 communicatively coupled to a transaction sights engine 1212 (which may be collectively referred to as an authentication platform 1214). Transaction insights enabled directory server 1210 and transaction insights engine 1212 facilitate performing a transaction insights analysis on behalf of ACS providers, as described herein. Transaction insights enabled directory server 1210 and transaction insights engine 1212 may be operated, for example, by interchange network 28 (shown in FIG. 1). In some embodiments, authentication platform 1214 is similar to authentication server 112 (shown in FIG. 2).

As in authentication system 500, transaction insights enabled directory server 1210 receives an AReq message from 3DS server 506. However, instead of immediately forwarding the AReq message to ACS 512, transaction insights enabled directory server 1210 transmits at least some of the data in the AReq message (e.g., the authentication data) to transaction insights engine 1212.

In the example embodiment, transaction insights engine 1212 analyzes the data in the AReq message to generate transaction insights result data. For example, transaction insights engine 1212 may compare the data in the AReq message to one or more long term variables (“LTV”). The one or more LTV may include historical authentication data associated with the PAN at issue, historical authorization data associated with the PAN, other historical data associated with the PAN, etc. The LTV may be associated with both card present and card not present historical transactions. For example, the LTV may include cardholder shipping address, cardholder billing address, cardholder email address, cardholder phone number, merchant name, merchant category, merchant location, and/or at least one environment-related variable (e.g., device details, browser details) including device ID, IP address, device channel, etc. Further, the LTV may be stored in a database accessible by transaction insights engine 1212 and operated by interchange network 28. In some embodiments, the LTV data will be hashed prior to storing to protect the security of this personally identifiable information.

In addition, the data in the AReq message may also be compared to other parameters. For example, to monitor consistency and changes in behavior, the data may be compared to short term (e.g., on the order of minutes, hours, or days) PAN velocities and ratios, including velocities and ratios of PAN authorization and authentication. This may include comparing to recent transaction frequency, amount spent, declines, historical risk scores, etc. Alternatively, the data in the AReq message may be analyzed using any suitable techniques to generate transaction insights result data, as described herein.

In the example embodiment, the transaction insights result data generated by transaction insights engine 1212 includes a risk score, a risk analysis, and at least one reason code. The risk score is a score representing a determined riskiness of the transaction, with lower scores indicating lower risk and higher scores indicating higher risk. In other words, the risk score represents a likelihood that the suspect cardholder (e.g., the person attempting to perform a transaction) is the legitimate cardholder having the privileges to use the payment card to perform a payment transaction. For example, the risk score may be represented by a number from 0-999 and/or by a risk threshold category from 0-19. In some embodiments, risks assessments that will be shared, such as through the authorization field of one or more messages will be quantified on a scale of 0-9. Those of skill in the art will appreciate that any suitable risk score may be used.

The transaction insights analysis is a description of a level of risk corresponding to the risk score (e.g., low risk, medium risk, or high risk). Further the reason codes include one or more factors that influenced the risk score. Transaction insights engine 1212 transmits the transaction insights result data to transaction insights enabled directory server 1210.

In some embodiments, the reason codes are generated based on a plurality of reason code categories and associated anchors. In some embodiments, the reason codes are affected by rules and/or a combination of the rules and the model. Specifically, different categories are established, and each category is associated with a plurality of activatable anchors, as described herein. Based on the analysis of the data in the AReq message, transaction insights engine 1212 may activate one or more anchors. The reason codes are then generated based on which anchors (and how many anchors) are activated.

For example, in one embodiment, three risk code categories are established: cardholder, merchant, and environment. In this example, the cardholder category is associated with five anchors (shipping address, PAN, billing address, email, and phone), the merchant category is associated with three anchors (merchant name, merchant category, and merchant country), and the environment category is associated with three anchors (device info, IP address, and device channel). Those of skill in the art will appreciate that additional and/or alternative anchors may be established.

Based on analysis of the data in the AReq message, transaction insights engine 1212 may activate at least one anchor. For example, for the cardholder category, if transaction insights engine 1212 determines that a shipping address for the transaction has been used with the PAN in past transactions and/or the shipping address is unchanged from prior transaction, transaction insights engine 1212 may activate the shipping address anchor. Further, transaction insights engine 1212 may activate the PAN anchor of the cardholder category if the PAN has had successful authentications in past transactions.

For the merchant category, one or more anchors may be activated based fraud rates for the merchant, decline rates for the merchant, and non-cleared transaction rates for the merchant. Further, one or more anchors may be activated when transaction insights engine 1212 determines the merchant category and merchant location for the transaction are consistent with historical transactions for that merchant.

For the environment category, the IP address anchor may be activated if the IP address is known and is not on a list of “bad” IP addresses. Further, the device anchor may be activated if the device is known and is not on a list of “bad” devices, the device has had successful authentications in past transactions, and/or the device has scored well in past transactions.

The following are some additional examples of criteria for activating anchors for the different categories. In one example, the shipping address anchor is activated if the shipping address has been used with the PAN in past transactions, the shipping address is the same as the billing address on file, the shipping address is not on a list of “bad” shipping addresses, and the shipping address is unchanged from a prior transaction. In a second example, the shipping address anchor, the billing address anchor, and the PAN anchor (i.e., all anchors for the cardholder category) are activated when the shipping address is consistent with previous transactions, the billing address is consistent with previous transactions, the PAN has historical positive association with the cardholder, and the purchase amount, date, and time are consistent with previous transactions. In a third example, anchors for both the cardholder category and the merchant category are activated when the contact information for the cardholder is consistent with previous transactions, the cardholder is a trusted cardholder, the merchant is a trusted merchant, and the PAN shows established activity and authentication history at the merchant. Those of skill in the art will appreciate that the anchors may be activated based on any suitable conditions.

The reasons codes are generated based on the activated anchors, and are loosely structured in a hierarchical order based on connections between anchors in different categories. For example, if at least one anchor in the cardholder category is activated, a positive reason code (i.e., indicating relatively low risk) is generated. If, instead, at least one anchor in the cardholder category is activated and at least one anchor in the merchant category is also activated, a stronger positive reason code related to both categories is generated. Similarly, if at least one anchor in the cardholder category is activated, at least one anchor in the merchant category is activated, and at least one anchor in the environment category is activated, an even stronger positive reason code related to all three categories is generated.

The following Table 4 lists of number of example reason codes. However, those of skill in the art will appreciate that additional and/or alternative reason codes may be utilized in accordance with the embodiments described herein.

TABLE 4

| Code | Reason Code Name | Description and Comments |
|---|---|---|
| A | Risk Event - Suspicious Account | Merchant or payment network has |
| | Activity | detected suspicious activity with |
| | | cardholder's account |
| B | Risk Event - Unknown | Merchant or payment network has not |
| | Device/Account Relationship | established a relationship between the |
| | | device and account |
| C | Risk Event - Device or Profile | The device used for the transaction or |
| | Information associated with fraud | the user's profile has been associated |
| | event | with a fraud event |
| D | Risk Event - Recent High Risk | The device used for the transaction or |
| | Change to Device or Profile | the user's profile has recently had a high |
| | Information | risk change |
| E | Risk Event - Recent change to Device | The device used for the transaction or |
| | or Profile Information | the user's profile has recently changed |
| F | Risk Event - PAN associated with | Merchant or payment network has |
| | fraud event | detected fraud associated with the PAN |
| | | used for this transaction |
| G | New Account or Insufficient Data | This is a new account with the merchant |
| | | (or new cardholder details to payment |
| | | network) or there is insufficient data for |
| | | this cardholder |
| H | Merchant/Acquirer: Merchant (fraud) | Payment network has determined that |
| | risk high (assessed by payment | the merchant is submitting transactions |
| | network) | with a high rate of fraud |
| I | Merchant/Acquirer: Merchant (fraud) | Payment network has determined that |
| | risk low (assessed by payment | the merchant is submitting transactions |
| | network) | with a higher rate of fraud than average |
| J | Environment: Good/Known IP | Merchant or payment network is |
| | | familiar with the IP address where the |
| | | transaction is happening and has |
| | | assessed that it is a good, trusted IP |
| K | Cardholder: Billing address - prior | Merchant or payment network has |
| | history established | established a positive association |
| | | between the cardholder and this billing |
| | | address |
| L | Cardholder: Email address - prior | Merchant or payment network has |
| | history established | established a positive association |
| | | between the cardholder and this email |
| | | address. |
| M | Cardholder: Phone number - prior | Merchant or payment network has |
| | history established | established a positive association |
| | | between the cardholder and this phone |
| | | number. |
| N | Cardholder: Shipping address - prior | Merchant or payment network has |
| | history established | established a positive association |
| | | between the cardholder and this |
| | | shipping address. |
| O | Cardholder: Card number (PAN) | Merchant or payment network has |
| | behavior established high trust in the | established high trust in the transaction |
| | current transaction | based on historical PAN behavior |
| P | Environment: Device known | Merchant or payment network has seen |
| | | the device used for the transaction |
| | | before, but this account might not be |
| | | established on device |
| Q | Environment: Account established on | Merchant or payment network has seen |
| | Device | this account transaction on this device |
| | | AND account has been authenticated on |
| | | the device |
| R | Environment: Session - | Merchant or payment network |
| | Trusted/normal/innocent session (no | determines quality of the session |
| | man in the middle attack/no bot, not | |
| | suspicious account activity) | |
| S | More than one cardholder category | Merchant or payment network has |
| | anchor established | established multiple cardholder category |
| | | anchors |
| T | More than one merchant category | Payment network has established |
| | anchor established | multiple merchant category anchors |
| U | More than one environment category | Merchant or payment network has |
| | anchor established | established multiple environment |
| | | category anchors |
| V | Co-occurring: established link | Merchant or payment network has |
| | between cardholder and merchant | established linkages across cardholder |
| | | and merchant categories |
| W | Co-occurring: established link | Merchant or payment network has |
| | between cardholder and environment | established linkages across cardholder |
| | | and environment categories |
| X | Co-occurring: established link | Payment network has established |
| | between merchant and environment | linkages across merchant and |
| | | environment categories |
| Y | All three categories established | Payment network has established |
| | | linkages across cardholder, merchant, |
| | | and environment categories |
| Z | Most Trusted (Reserved for future | Reserved for future use |
| | use) | |

After transaction insights engine 612 generates the transaction insights result data (including the reason codes), transaction insights enabled directory server 610 injects the transaction insights result data into the authorization request message to generate an enhanced authorization request message. For example, in some embodiments, the transaction insights result data is appended to the AReq message as an extensible markup language (XML) extension of the AReq message. For example, the extension may have the following format:

```
“name”: “ ACS DTI”,
“id”: “A000000004-acsDTI”,
“criticalityIndicator”: “true”,
“data”: {
  “status”:“success”,
  “score”:“150”,
  “decision”:“low risk”,
    “reasonCode1”:“Y”,
  “reasonCode2”:“J”}
```

where “score” is the risk score, “decision” is the risk analysis, and “reasonCode1” and “reasonCode2” are the reason codes. In the exemplary embodiment, the reason codes are transmitted as a single letter each. In other embodiments, the reason codes may be represented in different methods. In some embodiments, reasonCode2 is transmitted by the merchant to provide the merchant's assessment of the transaction. Alternatively, the transaction insights result data may be injected into the authorization request message to generate an enhanced authorization request message using any suitable process.

The enhanced message is then transmitted from transaction insights enabled directory server 610 to issuer 514. Issuer 514 then analyzes the transaction insights result data in the enhanced authorization message to make an authentication decision. That is, in the example embodiment, issuer 514 may determine to fully authenticate the transaction, deny authentication for the transaction, or perform additional authentication (e.g., by issuing a step-up challenge to the cardholder) for the transaction, based on at least one of the risk score, the risk analysis, and the reason codes. Accordingly, issuer 514 does not perform the transaction insights analysis, but is still able to leverage the results of that analysis to make an authentication decision (e.g., by using the results in their own fraud analysis platform), generally resulting in more approvals with less fraud. Thus, transaction insights enabled directory server 610 and transaction insights engine 612 perform the transaction insights analysis for issuer 514 and/or ACS 512.

In some embodiments, when the determined riskiness of the transaction is low enough, instead of generating and transmitting an enhanced authorization request message to issuer 514, transaction insights enabled directory server 610 fully authenticates the transaction itself. Specifically, when the determined riskiness of the transaction is low enough, identity insights enabled directory server 610 automatically generates an ARes that indicates the transaction has been fully authenticated, and transmits the ARes message to 3DS server 506. Transaction insights enabled directory server 610 determines that the riskiness of the transaction is low by comparing at least one of the risk score and the risk analysis to a predetermined threshold. The predetermined threshold may be specified, for example, by issuer 514 and/or ACS 512. Accordingly, issuer 514 and/or ACS 512 is able to control which transactions will be fully authenticated without all transactions being forwarded to issuer 514 and/or ACS 512.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as image data, text data, report data, and/or numerical analysis. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, the computer network hosting the computer device, services executing on the computer device, and/or other data.

Based upon these analyses, the processing element may learn how to identify characteristics and patterns that may then be applied to training models, analyzing transaction and authentication data, and detecting and analyzing a likelihood of fraudulent consumer identity.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An authentication platform for use in authenticating an online user, the authentication platform comprising:
a memory device; and
at least one processor coupled to the memory device, the at least one processor programmed to:
generate an authentication model using historical data, the historical data comprising at least historical consumer identity data;
receive, from a merchant computing device, an authentication request message for a current transaction, the authentication request message including consumer identity data for the current transaction;
extract the consumer identity data from the authentication request message;
generate, based at least in part on the extracted consumer identity data, identity insight result data including an identity score, the identity insight result data generated using the authentication model;
inject the identity insight result data into an authorization request message to generate an enhanced authorization request message; and
transmit the enhanced authorization request message to an issuer computing device.

2. The authentication platform of claim 1, wherein the identity insights result data further includes at least one reason code that indicates at least one factor that influenced the generated identity score.

3. The authentication platform of claim 2, wherein the at least one reason code comprises a first reason code and a second reason code, the combination of the first reason code and the second reason code providing one insight.

4. The authentication platform of claim 1, wherein the current consumer identity data comprises at least one of a consumer name, email address, phone number, IP address, billing address, or shipping address.

5. The authentication platform of claim 1, wherein the historical data is stored in a database accessible by the at least one processor.

6. The authentication platform of claim 5, wherein the database comprises authoritative identity data.

7. The authentication platform of claim 1, wherein the at least one processor is further configured to use the historical data to build a training dataset and use the training dataset to train the authentication model.

8. The authentication platform of claim 7, wherein the at least one processor is further configured to update the training dataset to include the current consumer identity data and an outcome associated with the current consumer identity data to generate an updated dataset, and re-train the authentication model using the updated training dataset.

9. The authentication platform of claim 1, wherein the identity score indicates a likelihood of identity fraud.

10. The authentication platform of claim 1, wherein the at least one processor is further configured to determine an identity fraud likelihood level based on the at least one of the identity score, wherein the identity fraud likelihood level is included in the identity insight result data.

11. A computer-implemented method for use in authenticating an online user, the method implemented on a computing device comprising a memory device coupled to at least one processor, and the method comprises:
generating an authentication model using historical data, the historical data comprising at least historical consumer identity data;
receiving, from a merchant computing device, an authentication request message for a current transaction, the authentication request message including consumer identity data for the current transaction;
extracting the consumer identity data from the authentication request message;
generating, based at least in part on the extracted consumer identity data, identity insight result data including an identity score, the identity insight result data generated using the authentication model;
injecting the identity insight result data into an authorization request message to generate an enhanced authorization request message; and
transmitting the enhanced authorization request message to an issuer computing device.

12. The method of claim 11, wherein the identity insights result data further includes at least one reason code that indicates at least one factor that influenced the generated identity score.

13. The method of claim 11, wherein the current consumer identity data comprises at least one of a consumer name, email address, phone number, IP address, billing address, or shipping address.

14. The method of claim 11, wherein the historical data is stored in a database accessible by the at least one processor.

15. The method of claim 14, wherein the database comprises authoritative identity data.

16. The method of claim 11, further comprising using the historical data to build a training dataset and use the training dataset to train the authentication model.

17. The method of claim 16, further comprising updating the training dataset to include the current consumer identity data and an outcome associated with the current consumer identity data to generate an updated dataset, and re-training the authentication model using the updated training dataset.

18. The method of claim 11, wherein the identity score indicates a likelihood of identity fraud.

19. The method of claim 11, further comprising determining an identity fraud likelihood level based on the at least one of the identity score, wherein the identity fraud likelihood level is included in the identity insight result data.

20. At least one non-transitory computer-readable storage media having computer-executable instructions embodied thereon for use in authenticating an online user, wherein when executed by at least one processor, the computer-executable instructions cause the at least one processor to:
generate an authentication model using historical data, the historical data comprising at least historical consumer identity data;
receive, from a merchant computing device, an authentication request message for a current transaction, the authentication request message including consumer identity data for the current transaction;
extract the consumer identity data from the authentication request message;
generate, based at least in part on the extracted consumer identity data, identity insight result data including an identity score, the identity insight result data generated using the authentication model;
inject the identity insight result data into an authorization request message to generate an enhanced authorization request message; and
transmit the enhanced authorization request message to an issuer computing device.
